(19) United States
(12) Patent Application Publication
(10) Pub. No.: US 2025/0294185 A1
(43) Pub. Date: Sep. 18, 2025

(54) SYSTEM AND METHOD FOR CHROMATICITY INTRA PREDICTION

(71) Applicant: GUANGDONG OPPO MOBILE TELECOMMUNICATIONS CORP., LTD., Dongguan, Guangdong (CN)

(72) Inventors: Kazushi SATO, Palo Alto, CA (US); Yue YU, Palo Alto, CA (US); Haoping YU, Palo Alto, CA (US)

(21) Appl. No.: 18/873,813

(22) PCT Filed: Jun. 13, 2023
(86) PCT No.: PCT/US2023/025179

§ 371 Date: Dec. 11, 2024

Related U.S. Application Data
(60) Provisional application No. 63/366,596, filed on Jun. 17, 2022.
(60) Provisional application No. 63/385,310, filed on Nov. 29, 2022.

(51) Int. Cl. H04N 19/593; H04N 19/184; H04N 19/186

(52) U.S. Cl. CPC H04N 19/593; H04N 19/184; H04N 19/186

(57) ABSTRACT

According to one aspect of the present disclosure. a method of encoding by an encoder is provided. The method may include identifying a first set of reference lines non-adjacent to a luma coding unit (CU). The method may include performing a luminance (luma) intra prediction procedure based on the first set of reference lines. The method may include obtaining a set of luma pixel values for the luma CU based on the luma intra prediction procedure. The method may include identifying a second set of reference lines non-adjacent to a chromaticity (chroma) CU based on the first set of reference lines. The method may include estimating a correlation function associated with the chroma CU based on the first set of reference lines non-adjacent to the luma CU. the second set of reference lines non-adjacent to the chroma CU, and the set of luma pixel values for the luma CU.

### CROSS-REFERENCE TO RELATED APPLICATIONS

This application is a national phase entry under 35 USC 371 of International Patent Application No. PCT/US2023/025179 filed on Jun. 13, 2023, which claims the benefit of priorities to U.S. Provisional Application No. 63/366,596, entitled “CHROMA INTRA PREDICTION METHOD” and filed on Jun. 17, 2022, and to U.S. Provisional Application No. 63/385,310, entitled “CHROMA INTRA PREDICTION METHOD” and filed on Nov. 29, 2022. Disclosures of the above are incorporated by reference herein in their entireties.

### BACKGROUND

Embodiments of the present disclosure relate to video coding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method of encoding by an encoder is provided. The method may include identifying, by at least one processor, a first set of reference lines non-adjacent to a luma coding unit (CU). The method may include performing, by the at least one processor, a luma intra prediction procedure based on the first set of reference lines non-adjacent to the luma CU. The method may include obtaining, by the at least one processor, a set of luma pixel values for the luma CU based on the luma intra prediction procedure. The method may include identifying, by the at least one processor, a second set of reference lines non-adjacent to a chroma CU based on the first set of reference lines non-adjacent to the luma CU. The method may include estimating, by the at least one processor, a correlation function associated with the chroma CU based on the first set of reference lines non-adjacent to the luma CU, the second set of reference lines non-adjacent to the chroma CU, and the set of luma pixel values for the luma CU.

According to another aspect of the present disclosure, a system for encoding by an encoder is provided. The system may include at least one processor and memory storing instructions. The memory storing instructions, which when executed by the at least one processor, may cause the at least one processor to identify a first set of reference lines non-adjacent to a luma CU. The memory storing instructions, which when executed by the at least one processor, may cause the at least one processor to perform a luma intra prediction procedure based on the first set of reference lines non-adjacent to the luma CU. The memory storing instructions, which when executed by the at least one processor, may cause the at least one processor to obtain a set of luma pixel values for the luma CU based on the luma intra prediction procedure. The memory storing instructions, which when executed by the at least one processor, may cause the at least one processor to identify a second set of reference lines non-adjacent to a chroma CU based on the first set of reference lines non-adjacent to the luma CU. The memory storing instructions, which when executed by the at least one processor, may cause the at least one processor to estimate a correlation function associated with the chroma CU based on the first set of reference lines non-adjacent to the luma CU, the second set of reference lines non-adjacent to the chroma CU, and the set of luma pixel values for the luma CU.

According to a further aspect of the present disclosure, a method of decoding by a decoder is provided. The method may include receiving, by a communication interface, a bitstream that includes a set of luma pixel values associated with a luma CU and a set of chroma pixel values associated with a chroma CU from an image encoder. The method may include identifying, by at least one processor, a correlation function associated with a first set of reference lines non-adjacent to the luma CU and used to generate the set of luma pixel values by the image encoder and a second set of reference lines non-adjacent to the chroma CU and used to generate the set of chroma pixel values by the image encoder.

According to still another aspect of the present disclosure, a system for decoding by a decoder is provided. The system may include at least one processor and memory storing instructions. The memory storing instructions, which when executed by the at least one processor, may cause the at least one processor to receive a bitstream that includes a set of luma pixel values associated with a luma CU and a set of chroma pixel values associated with a chroma CU from an image encoder. The memory storing instructions, which when executed by the at least one processor, may cause the at least one processor to identify a correlation function associated with a first set of reference lines non-adjacent to the luma CU and used to generate the set of luma pixel values by the image encoder and a second set of reference lines non-adjacent to the chroma CU and used to generate the set of chroma pixel values by the image encoder.

These illustrative embodiments are mentioned not to limit or define the present disclosure, but to provide examples to aid understanding thereof. Additional embodiments are described in the Detailed Description, and further description is provided there.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a diagram of an example multiple-reference line (MRL) intra prediction procedure for image encoding.

FIG. 2 illustrates a diagram of an extension to the example MRL intra prediction procedure for image encoding of FIG. 1.

FIG. 3 illustrates a diagram of luminance (luma) and chromaticity (chroma) samples used for cross-component linear model (CCLM) parameter derivation.

FIG. 4 illustrates a graphical representation of a slope adjustment procedure for CCLM intra prediction.

FIG. 5A illustrates a diagram of a single-tree partition for VVC.

FIG. 5B illustrates a diagram of a dual-tree partition for VVC.

FIG. 6 illustrates a diagram of example reference lines for a luma intra prediction procedure and a chroma intra prediction procedure.

FIG. 7 illustrates a block diagram of an exemplary encoding system, according to some embodiments of the present disclosure.

FIG. 8 illustrates a block diagram of an exemplary decoding system, according to some embodiments of the present disclosure.

FIG. 9 illustrates a detailed block diagram of an exemplary encoder in the encoding system in FIG. 8, according to some embodiments of the present disclosure.

FIG. 10 illustrates a detailed block diagram of an exemplary decoder in the decoding system in FIG. 9, according to some embodiments of the present disclosure.

FIG. 11 illustrates an exemplary picture divided into coding tree units (CTUs), according to some embodiments of the present disclosure.

FIG. 12 illustrates an exemplary CTU divided into coding units (CUs), according to some embodiments of the present disclosure.

FIG. 13A illustrates a diagram of a first exemplary intra prediction procedure that uses a first set of reference lines non-adjacent to the luma CU and a second set of reference lines non-adjacent to the chroma CU, according to some embodiments of the present disclosure.

FIG. 13B illustrates a diagram of a second exemplary intra prediction procedure that uses a first set of reference lines non-adjacent to the luma CU and a second set of reference lines non-adjacent to the chroma CU, according to some embodiments of the present disclosure.

FIG. 13C illustrates a third exemplary intra prediction procedure that uses a first set of reference lines non-adjacent to the luma CU and a second set of reference lines non-adjacent to the chroma CU, according to some embodiments of the present disclosure.

FIGS. 14A and 14B illustrate a flowchart of an exemplary method of video encoding, according to some embodiments of the present disclosure.

FIG. 15 illustrates a flowchart of an exemplary method of video decoding, according to some embodiments of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block” and “unit” may be used interchangeably.

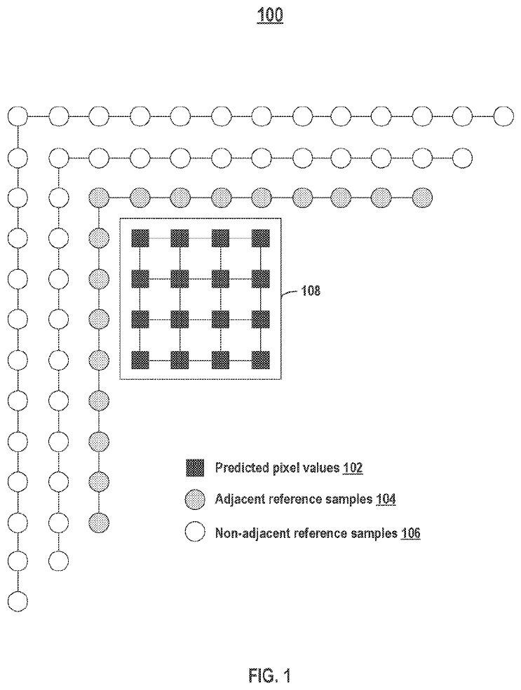

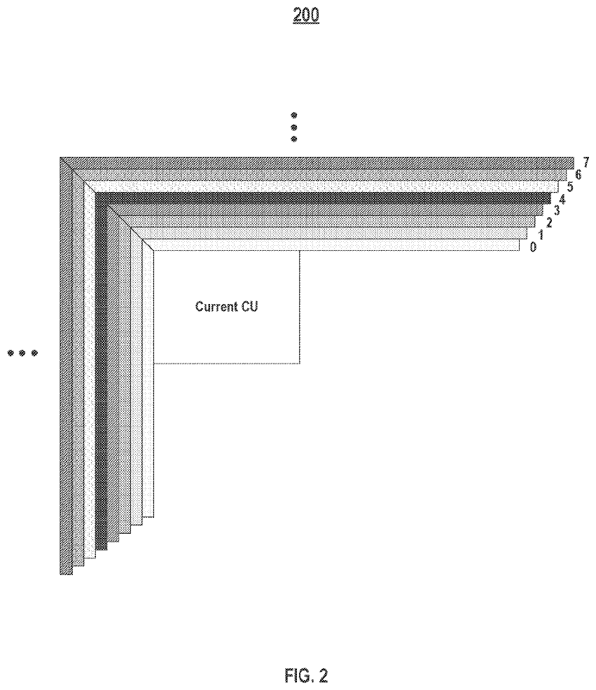

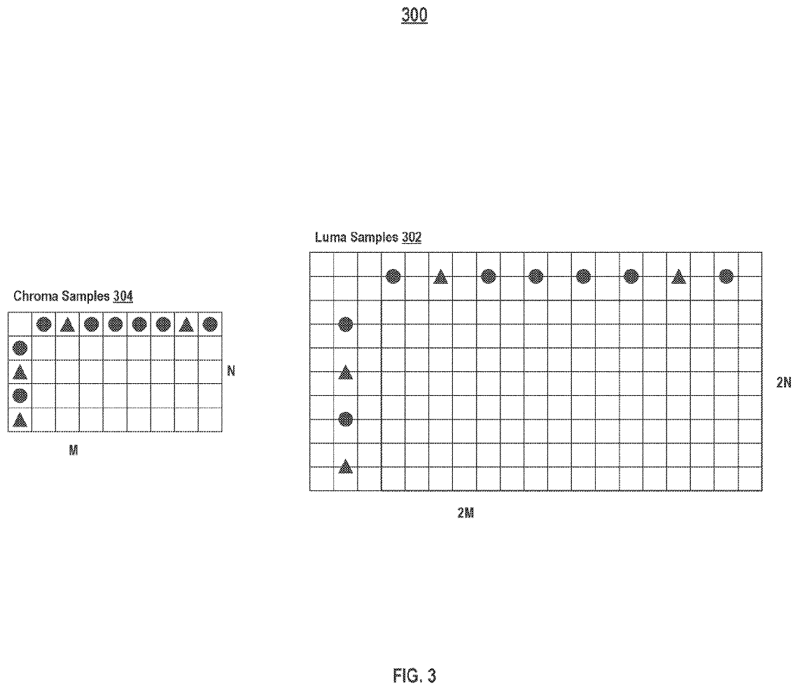

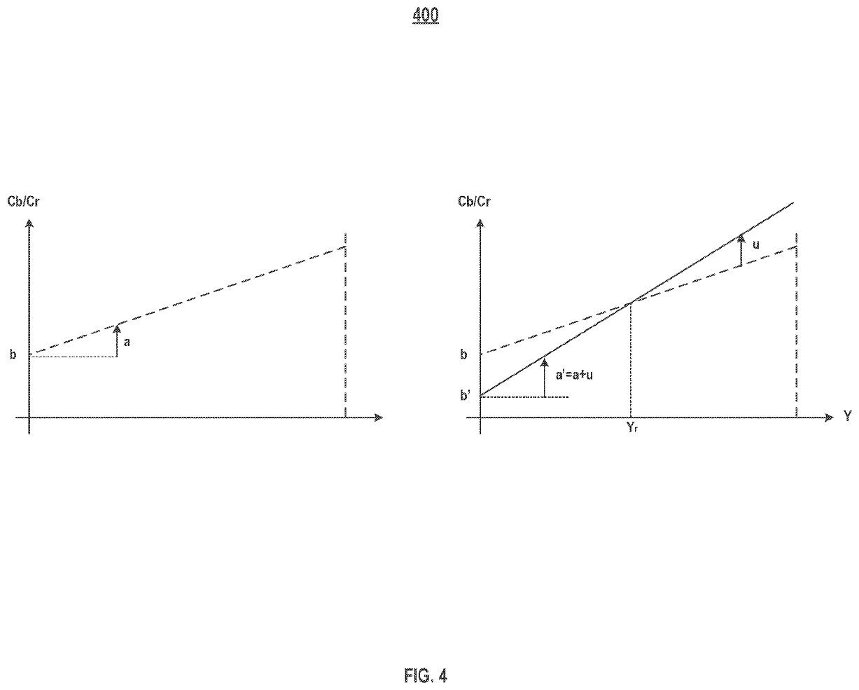

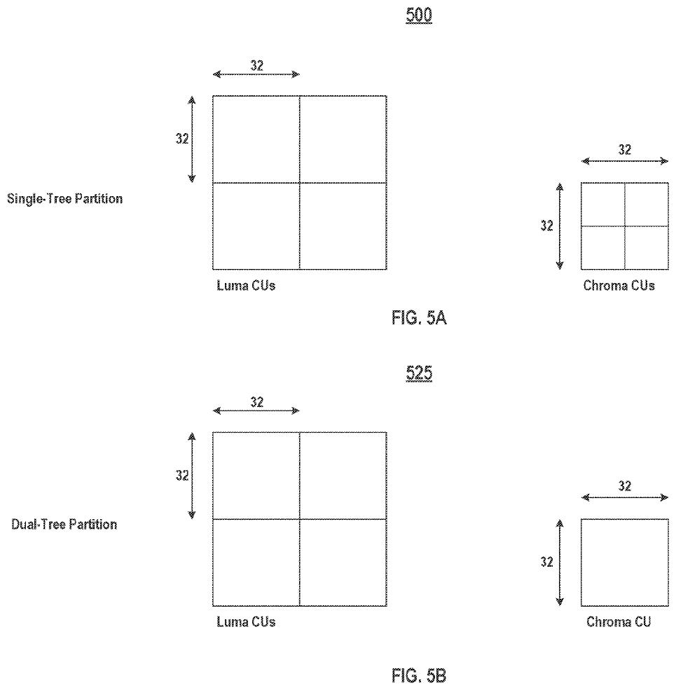

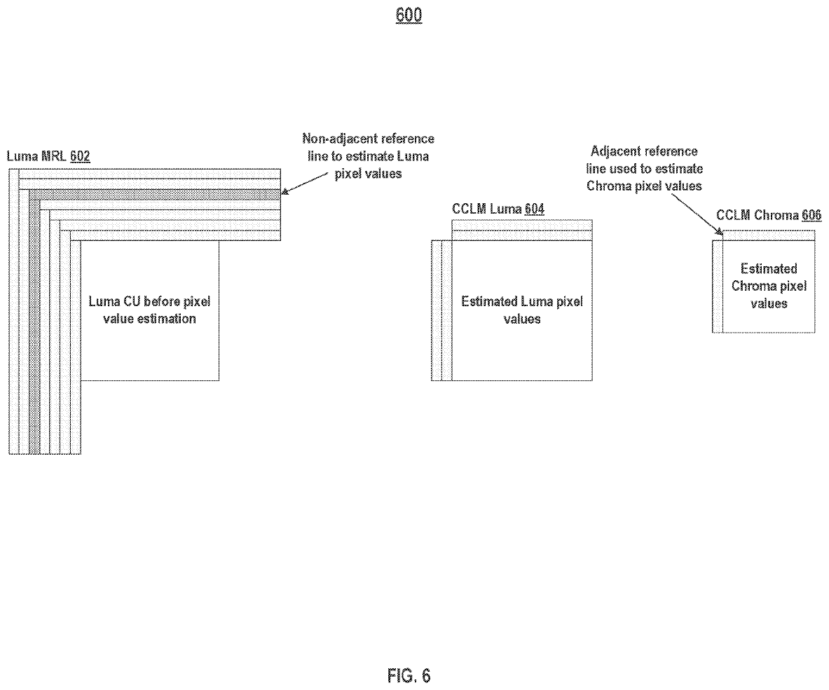

FIG. 1 illustrates a diagram 100 of an example multiple-reference line (MRL) intra prediction procedure for image encoding. FIG. 2 illustrates a diagram 200 of an extension to the example MRL intra prediction procedure for image encoding of FIG. 1. FIG. 3 illustrates a diagram 300 of luma samples 302 and chroma samples 304 used for CCLM parameter derivation. FIG. 4 illustrates a graphical representation 400 of a slope adjustment procedure for CCLM intra prediction. FIG. 5A illustrates a diagram 500 of a singe-tree partition for VVC. FIG. 5B illustrates a diagram 525 of a dual-tree partition for VVC. FIG. 6 illustrates a diagram 600 of example reference lines for a luma intra prediction procedure and a chroma intra prediction procedure.

Referring to FIG. 1, in versatile video coding (VVC), in addition to the reference samples 104 in the reference lines directly adjacent to the coding unit (CU) 108, one of the non-adjacent reference lines that include non-adjacent reference samples 106 can be used for an intra prediction procedure to predict pixel values 102. The latter use of non-adjacent reference samples 106 is referred to as the multiple-reference line (MRL) prediction. In VVC, MRL is disabled and not signaled for the coding units (CUs) that are located at the top of the coding tree unit (CTU) to minimize the cost of implementation. MRL is only applied when the intra prediction mode of the current prediction block is coded with the most-probable mode (MPM), but not including the planar mode.

In the Bitstream, MRL can be Enabled or Disabled Using a Sequence-Parameter Set (SPS) Descriptor, as Shown in Table 1.

TABLE 1
Syntax of SPS defined in VVC Specification

| | Descriptor |
|---|---|
| seq_parameter_set_rbsp( ) { | |
| ... | |
| sps_mrl_enabled_flag | u(1) |
| ... | |
| } | |

If the Value of Sps_Mrl_Enabled_Flag is Set to 1, which Line in FIG. 1 is Applied for Intra Prediction is Specified in the Coding_Unit( ) Syntax, as Shown in Table 2.

TABLE 2
Syntax of coding_unit( ) defined in VVC Specification

| | Descriptor |
|---|---|
| coding_unit( x0, y0, cbWidth, cbHeight, cqtDepth, treeType, modeType ) { | |
| ... | |
| } else { | |
| if( sps_mrl_enabled_flag && ( ( y0 % CtbSizeY ) > 0 ) ) | |
| intra_luma_ref_idx | ae(v) |
| ... | |
| } | |

Referring to FIG. 2, an extension of MRL has been proposed. In this proposal, an extended MRL list is defined as N∈{1, 3, 5, 7, 12} where the number N starting from 0 represents the (N+1)th top and left reference lines. For template-based intra mode derivation (TIMD), the MRL list is N∈{1, 3}.

In VVC, a chroma intra prediction mode named CCLM is specified. Referring to FIG. 3, luma samples 302 and chroma samples 304 may be used for CCLM parameter derivation. For typical image or video content, signal correlations can be observed between a pixel's color components. CCLM mode makes use of inter-channel correlations by predicting chroma samples 304 from luma samples 302, which are reconstructed using MRL. Chroma intra prediction is carried out using a linear model function, such as expression (1).

$$P ( i , j ) = a * {rec}_{L}^{’} ( i , j ) + b , \qquad ( 1 )$$

where P(i,j) represents chroma samples 304 in a CU and rec′L (i,j) represents luma samples 302 of the same CU. Luma samples 302 may be down-sampled by a ratio of 2:1 for the case of a 4:2:0 color format. CCLM parameters a and b may be derived based on luma samples 302 and chroma samples 304.

Three CCLM modes, e.g., namely, CCLM left and top (CCLM_LT), CCLM left (CCLM_L), and CCLM top (CCLM_T), are specified in VVC. These three modes differ with respect to the locations of the reference samples that are used for deriving model parameters “a” and “b.” Samples from the top boundary are involved in the CCLM_T mode, and samples from the left boundary are involved in the CCLM_L mode. In the CCLM_LT mode, samples from both the top boundary and the left boundary are used. Overall, the chroma intra prediction procedure using one of the CCLM modes includes, e.g., 1) down-sampling of the luma block and its neighboring reconstructed samples to match the size of the corresponding chroma block, 2) model parameter derivation based on the reconstructed neighboring samples, and 3) application of expression (1) to generate the chroma intra prediction samples.

With respect to the operation associated with the down-sampling of the luma CU, to match the chroma location for video sequences with 4:2:0 color format, two types of down-sampling filters can be applied to luma samples 302. Both types of down-sampling filters may have a 2-to-1 down-sampling ratio in the horizontal and the vertical directions. These two filters (f₁ and f₂), which are given below in expression (2) as an example, correspond to the video content with the “type-0” and “type-2” 4:2:0 chroma format, respectively,

$${f}_{1} = ( \begin{matrix}0 & 1 & 0 \\ 1 & 4 & 1 \\ 0 & 1 & 0\end{matrix} ) , {f}_{2} = ( \begin{matrix}1 & 2 & 1 \\ 1 & 2 & 1\end{matrix} ) . \qquad ( 2 )$$

Based on the SPS-level flag information, the 2-dimensional 6-tap or 5-tap filter is applied to luma samples 302 within the current block as well as its neighboring samples. An exception happens if the top line of the current block is a CTU boundary. In this case, a one-dimensional filter [1, 2, 1]/4 is applied to the above neighboring luma samples 302 to avoid the usage of more than one luma line above the CTU boundary.

With respect to the model parameter derivation process, model parameters “a” and “b” from operation (1) are derived based on the reconstructed luma samples 302 and chroma samples 304 at both the encoder and decoder to avoid any signaling overhead in VVC.

Referring again to FIG. 3, the relative sample locations of an M×N chroma block, the corresponding 2M×2N luma block, luma samples 302, and chroma samples 304 are shown. In FIG. 3, the four samples used in the CCLM_LT mode are also shown, which are marked by the triangular shapes. They are located at the positions of M/4 and 3*M/4 at the top boundary and at the positions of N/4 and 3*N/4 at the left boundary. In CCLM_T and CCLM_L modes, the top and the left boundary are extended to the size of (M+N) samples, and the four samples used for the model parameter derivation are located at the positions (M+N)/8, 3*(M+N)/8, 5*(M+N)/8, and 7*(M+N)/8.

Once the four samples are selected, four comparison-operations are used to determine the two smallest and the two largest luma sample values among them. For instance, let X₁ denote the average of the two largest luma sample values and Xₛ denote the average of two smallest luma sample values. Similarly, let Y₁ and Yₛ denote the average of the corresponding chroma sample values. Then the linear model parameters “a” and “b” are obtained according to expression (3).

$$a = \frac{{Y}_{l} - {Y}_{s}}{{X}_{l} - {X}_{s}} ; b = {Y}_{s} - a * {X}_{s} . \qquad ( 3 )$$

In expression (3), the division operation to calculate the parameter “a” is implemented with a look-up table. To reduce the amount of memory that stores the look-up table, the difference value, which is the difference between the maximum and minimum values, and the parameter “a” are expressed by an exponential notation. Here, the difference value is approximated with a 4-bit significant part and an exponent. Consequently, the table for 1/difference value includes 16 elements. This has the benefit of both reducing the complexity of the calculation and decreasing the memory size required for storing the tables.

To improve coding efficiency, an enhanced compression model (ECM) has been proposed. In ECM, an extension of CCLM referred to as a multi-model linear model (MMLM) has been adopted. In each MMLM mode, the reconstructed neighboring samples are classified into two classes using a threshold, which is the average of luma samples 302. The linear model of each class is derived using the least-mean square (LMS) procedure instead of the above method in VVC.

Referring to FIG. 4, a slope adjustment for the parameter “a” in expression (1) may further improve the coding performance of CCLM. For example, CCLM uses a model with two parameters to map luma values (lumaVal) to chroma values (chromaVal). The slope parameter “a” and the bias parameter “b” define the mapping according to expression (4).

$$chromaVal = a * lumaVal + b . \qquad ( 4 )$$

Moreover, a slope adjustment parameter “u” can be used to update the slope parameter to update the model according to expression (5).

$$chromaVal = a ’ * lumaVal + b ’ \qquad ( 5 )$$

where a′=a+u, b′=b−u*yᵣ, and yᵣ is an average of value of luma samples 302.

Still referring to FIG. 4, the slope adjustment parameter “u” is provided as an integer between −4 and 4, inclusive, and signaled in the bitstream. The unit of the slope adjustment parameter is ⅛th of a chroma sample value per one luma sample value (e.g., for 10-bit content). The slope adjustment parameter may be used for CCLM procedures that use reference samples both above and left of the CU (e.g., “LM_CHROMA_IDX” and “MMLM_CHROMA_IDX”), but not for the “single side” modes. T his selection is based on a trade-off between coding efficiency and complexity trade-off considerations. When slope adjustment is applied for a multi-mode CCLM model, both models can be adjusted; and thus, up to two slope updates may be signaled for a single chroma CU.

In high-efficiency video coding (HVEC), the coding tree of a CTU is shared by its Y, Cb, and Cr components, so that one CU consists of one luma CU and two chroma CUs. In VVC, this single tree structure is retained for P and B slices. However, in I slices, the luma and chroma components' spatial characteristics may differ. Generally, luma has a finer texture than chroma, which results in a higher number of smaller CUs in a luma CTU than those in a chroma CTU. Thus, it is reasonable to use separate coding trees for the luma and chroma components in I slices. In this case, a luma CTU (containing only one luma coding-tree block (CTB) of the original CTU) forms one coding tree, and a chroma CTU (containing only two chroma CTBs of the original CTU) forms a chroma separate tree (CST). In VVC, this CST design in I slices is referred to as a “dual-tree CTU.”

Starting CST partitioning from the CTU level requires signaling luma CTB first, followed by signaling chroma CTBs. Therefore, a decoder must process and store a 128×128 Luma block before processing the corresponding 64×64 chroma CTBs. Such processing order results in four times the buffer size compared to that without the CTU dual tree. To reduce the buffer requirement in VVC, a CST starts at the maximum TU (Transform Unit) level instead of the CTU level.

For the common test conditions (CTCs) in a VVC test model, each CTU may include 128×128 luma samples and 2×64×64 chroma samples in I slices and is split into four 64×64-L/32×32-C coding tree nodes using a quad-tree (QT) split procedure. The Two separate coding trees (one is the luma coding tree, and the other is the CST) start at each of the four 64×64-L/32×32-C coding tree nodes. When CCLM mode is selected as a chroma intra prediction procedure for the current chroma CUs, the following samples are involved in the process of generating chroma prediction samples: 1) the reconstructed samples from the chroma neighboring blocks of the current chroma CBs, 2) the reconstructed samples from the corresponding luma neighboring blocks and the luma collocated block of the current chroma CBs. In the case where there is a single partition tree with CCLM chroma CUs, the partitions of luma and chroma components are aligned. The reconstruction of any chroma samples in the current Cb/Cr CB can be performed after the samples are reconstructed.

Thus, as shown in FIG. 5A, if the same CU partitions are applied to the 64×64 luma coding node and the corresponding 32×32 chroma coding tree node, there is no need to wait for the reconstruction of an entire luma CU before starting to reconstruct its corresponding Cb/Cr CU. However, when a CTU has a dual-tree partition, the CU partitions between the luma and chroma components might differ, resulting in different processing orders of the luma and chroma CUs, as shown in FIG. 5B, for example. The related SPS syntax (seq_parameter_set_rbsp( ) is illustrated below in Table 3. Syntax elements related to the tree structure and one or more of the syntax elements of Table 3 may be transmitted as part of the bitstream.

TABLE 3
seq_parameter_set_rbsp( ) syntax element

| | Descriptor |
|---|---|
| seq_parameter_set_rbsp( ) { | |
| ... | |
| if( sps_chroma_format_idc != 0 ) | |
| sps_qtbtt_dual_tree_intra_flag | u(1) |
| if( sps_qtbtt_dual_tree_intra_flag ) { | |
| sps_log2_diff_min_qt_min_cb_intra_slice_chroma | ue(v) |
| sps_max_mtt_hierarchy_depth_intra_slice_chroma | ue(v) |
| if( sps_max_mtt_hierarchy_depth_intra_slice_chroma != 0 ) { | |
| sps_log2_diff_max_bt_min_qt_intra_slice_chroma | ue(v) |
| sps_log2_diff_max_tt_min_qt_intra_slice_chroma | ue(v) |
| } | |
| } | |
| ... | |
| } | |

Referring to Table 3, an sps_qtbtt_dual_tree_intra_flag value equal to 1 specifies that, for I slices, each CTU is split into coding units with 64×64 luma samples using an implicit quadtree split, and these coding units are the root of two separate coding_tree syntax structure for luma and chroma. An sps_qtbtt_dual_tree_intra_flag value equal to 0 specifies separate coding_tree syntax structure is not used for I slices. When sps_qtbtt_dual_tree_intra_flag is not present, it is inferred to be equal to 0. When sps_log 2_diff_max_bt_min_qt_intra_slice_luma is greater than Min(6, CtbLog2SizeY)−MinQtLog2SizeIntraY, the value of sps_qtbtt_dual_tree_intra_flag shall be equal to 0.

The sps_log 2_diff_min_qt_min_cb_intra_slice_chroma syntax element specifies the default difference between the base-2 logarithm of the minimum size in luma samples of a chroma leaf block resulting from quadtree splitting of a chroma CTU with treeType equal to DUAL_TREE_CHROMA and the base-2 logarithm of the minimum coding block size in the luma samples for chroma CUs with treeType equal to DUAL_TREE_CHROMA in slices with sh_slice_type equal 2 referring to (I) to the SPS. When sps_partition_constraints_override_enabled_flag value is equal to 1, the default difference can be overridden by ph_log 2_diff_min_qt_min_cb_chroma present in PH syntax structures referring to the SPS. The value of sps_log 2_diff_min_qt_min_cb_intra_slice_chroma may be in the range of 0 to Min(6, CtbLog2SizeY)−MinCbLog2SizeY, inclusive. When not present, the value of sps_log 2_diff_min_qt_min_cb_intra_slice_chroma is inferred to be equal to 0. The base-2 logarithm of the minimum size in luma samples of a chroma leaf block resulting from quadtree splitting of a CTU with treeType equal to DUAL_TREE_CHROMA is derived according to expression (6).

$$Min Qt Log 2 SizeIntraC = sps\_log2 \_diff \_min \_qt \_min \_cb \_intra \_slice \_chroma + Min Cb Log 2 SizeY . \qquad ( 6 )$$

The sps_max_mtt_hierarchy_depth_intra_slice_chroma syntax element specifies the default maximum hierarchy depth for chroma coding units resulting from multi-type tree splitting of a chroma quadtree leaf with treeType equal to DUAL_TREE_CHROMA into slices with sh_slice_type equal 2 (I) to referring to the SPS. When sps_partition_constraints_override_enabled_flag value is equal to 1, the default maximum hierarchy depth can be overridden by ph_max_mtt_hierarchy_depth_chroma present in PH syntax structures referring to the SPS. The value of sps_max_mtt_hierarchy_depth_intra_slice_chroma syntax element may be in the range of 0 to 2*(CtbLog2SizeY−MinCbLog2SizeY), inclusive. When not present, the value of sps_max_mtt_hierarchy_depth_intra_slice_chroma may be inferred to be equal to 0.

The sps_log 2_diff_max_bt_min_qt_intra_slice_chroma syntax element specifies the default difference between the base 2 logarithm of the maximum size (width or height) in luma samples of a chroma coding block that can be split using a binary split and the base-2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) referring to the SPS. When sps_partition_constraints_override_enabled_flag value is equal to 1, the default difference can be overridden by ph_log 2_diff_max_bt_min_qt_chroma present in PH syntax structures referring to the SPS. The value of sps_log 2_diff_max_bt_min_qt_intra_slice_chroma shall be in the range of 0 to Min(6, CtbLog2SizeY)−MinQtLog2SizeIntraC, inclusive. When sps_log 2_diff_max_bt_min_qt_intra_slice_chroma is not present, the value of sps_log 2_diff_max_bt_min_qt_intra_slice_chroma is inferred to be equal to 0.

The sps_log 2_diff_max_tt_min_qt_intra_slice_chroma syntax element specifies the default difference between the base-2 logarithm of the maximum size (width or height) in luma samples of a chroma coding block that can be split using a ternary split and the base-2 logarithm of the minimum size (width or height) in luma samples of a chroma leaf block resulting from quadtree splitting of a chroma CTU with treeType equal to DUAL_TREE_CHROMA in slices with sh_slice_type equal to 2 (I) referring to the SPS. When sps_partition_constraints_override_enabled_flag value is equal to 1, the default difference can be overridden by ph_log 2_diff_max_tt_min_qt_chroma present in PH syntax structures referring to the SPS. The value of sps_log 2_diff_max_tt_min_qt_intra_slice_chroma shall be in the range of 0 to Min(6, CtbLog2SizeY)−MinQtLog2SizeIntraC, inclusive. When sps_log 2_diff_max_tt_min_qt_intra_slice_chroma is not present, the value of sps_log 2_diff_max_tt_min_qt_intra_slice_chroma may be inferred to be equal to 0.

The coding_unit( ) syntax element is shown below in Table 4.

TABLE 4
coding_unit( ) syntax element

| | Descriptor |
|---|---|
| coding_unit( x0, y0, cbWidth, cbHeight, cqtDepth, treeType, modeType ) { | |
| ... | |
| chType = treeType = = DUAL_TREE_CHROMA ? 1 : 0 | |
| ... | |
| ... | |
| if( CclmEnabled ) | |
| cclm_mode_flag | ae(v) |
| if( cclm_mode_flag ) | |
| cclm_mode_idx | ae(v) |
| ... | |
| } | |

Depending on whether the value of the parameter “treeType” is equal to DUAL_TREE_CHROMA, whether the CST is applied for the current CU can be determined. Here, syntax elements cclm_mode_flag and cclm_mode_idx may be transmitted in the bitstream.

A cclm_mode_flag value equal to 1 specifies that one of the INTRA_LT_CCLM, INTRA_L_CCLM and INTRA_T_CCLM chroma intra prediction modes is applied. cclm_mode_flag equal to 0 specifies that none of the INTRA_LT_CCLM, INTRA_L_CCLM and INTRA_T_CCLM chroma intra prediction modes is applied. When cclm_mode_flag is not present, it is inferred to be equal to 0. The cclm_mode_idx syntax element specifies which one of the INTRA_LT_CCLM, INTRA_L_CCLM and INTRA_T_CCLM chroma intra prediction modes is applied.

Referring to FIG. 6, using existing VVC techniques, the reference lines for the MRL luma intra prediction 602, CCLM luma intra prediction 604, CCLM chroma intra prediction 606 may be different, as shown in FIG. 6. If the first above line of the luma block contains noise, using this line for luma intra prediction does not provide the best coding efficiency. In this case, an alternative reference line is used for luma intra prediction. Even in this case, the first and second above lines are always used for CCLM intra prediction. When the tree structure of Y, Cb, and Cr components is shared, it causes a loss in coding efficiency.

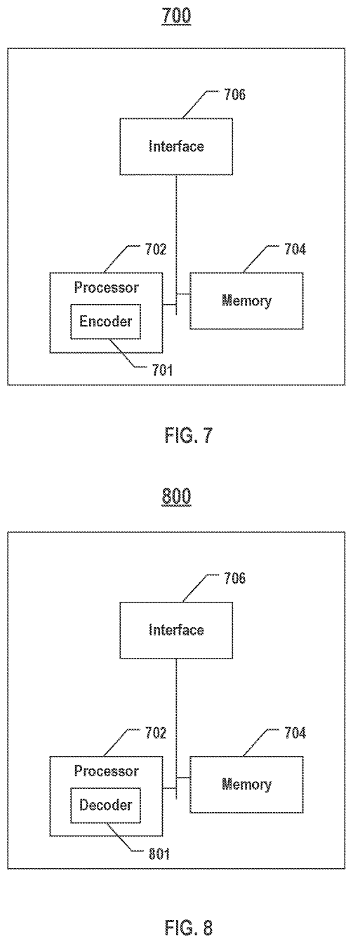

To overcome these and other challenges, the present disclosure provides an exemplary intra prediction procedure in which reference lines non-adjacent to the chroma CU may be used for chroma intra prediction. For example, in some embodiments, the same reference line for luma MRL intra prediction is applied to CCLM chroma intra prediction if the tree structure of Y, Cb, and Cr is shared. Otherwise, the reference lines defined by the legacy VVC specification is used for CCLM chroma intra prediction. In some embodiments, the reference line index for CCLM chroma intra prediction may be transmitted independently from the reference line index for luma MRL intra prediction. In some embodiments, if the tree structure of Y, Cb, and Cr is shared, the difference (a delta value) between the reference line index for CCLM chroma intra prediction and the reference line index for luma MRL intra prediction is transmitted instead of the corresponding reference line indices. Additional details of the exemplary intra prediction procedure are provided below in connection with FIGS. 7-15.

FIG. 7 illustrates a block diagram of an exemplary encoding system 700, according to some embodiments of the present disclosure. FIG. 8 illustrates a block diagram of an exemplary decoding system 800, according to some embodiments of the present disclosure. Each system 700 or 800 may be applied or integrated into various systems and apparatus capable of data processing, such as computers and wireless communication devices. For example, system 700 or 800 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 7 and 8, system 700 or 800 may include a processor 702, a memory 704, and an interface 706. These components are shown as connected to one another by a bus, but other connection types are also permitted. It is understood that system 700 or 800 may include any other suitable components for performing functions described here.

Processor 702 may include microprocessors, such as a graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 7 and 8, it is understood that multiple processors can be included. Processor 702 may be a hardware device having one or more processing cores. Processor 702 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 704 can broadly include both memory (a.k.a, primary/system memory) and storage (a.k.a. secondary memory). For example, memory 704 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 702. Broadly, memory 704 may be embodied by any computer-readable medium, such as a non-transitory computer-readable medium. Although only one memory is shown in FIGS. 7 and 8, it is understood that multiple memories can be included.

Interface 706 can broadly include a data interface and a communication interface that is configured to receive and transmit a signal in a process of receiving and transmitting information with other external network elements. For example, interface 706 may include input/output (I/O) devices and wired or wireless transceivers. Although only one interface is shown in FIGS. 7 and 8, it is understood that multiple interfaces can be included.

Processor 702, memory 704, and interface 706 may be implemented in various forms in system 700 or 800 for performing video coding functions. In some embodiments, processor 702, memory 704, and interface 706 of system 700 or 800 are implemented (e.g., integrated) on one or more system-on-chips (SoCs). In one example, processor 702, memory 704, and interface 706 may be integrated on an application processor (AP) SoC that handles application processing in an operating system (OS) environment, including running video encoding and decoding applications. In another example, processor 702, memory 704, and interface 706 may be integrated on a specialized processor chip for video coding, such as a GPU or ISP chip dedicated to image and video processing in a real-time operating system (RTOS).

As shown in FIG. 7, in encoding system 700, processor 702 may include one or more modules, such as an encoder 701. Although FIG. 7 shows that encoder 701 is within one processor 702, it is understood that encoder 701 may include one or more sub-modules that can be implemented on different processors located closely or remotely with each other. Encoder 701 (and any corresponding sub-modules or sub-units) can be hardware units (e.g., portions of an integrated circuit) of processor 702 designed for use with other components or software units implemented by processor 702 through executing at least part of a program, i.e., instructions. The instructions of the program may be stored on a computer-readable medium, such as memory 704, and when executed by processor 702, it may perform a process having one or more functions related to video encoding, such as picture partitioning, inter prediction, intra prediction, transformation, quantization, filtering, entropy encoding, etc., as described below in detail.

Similarly, as shown in FIG. 8, in decoding system 800, processor 702 may include one or more modules, such as a decoder 801. Although FIG. 8 shows that decoder 801 is within one processor 702, it is understood that decoder 801 may include one or more sub-modules that can be implemented on different processors located closely or remotely with each other. Decoder 801 (and any corresponding sub-modules or sub-units) can be hardware units (e.g., portions of an integrated circuit) of processor 702 designed for use with other components or software units implemented by processor 702 through executing at least part of a program, i.e., instructions. The instructions of the program may be stored on a computer-readable medium, such as memory 704, and when executed by processor 702, it may perform a process having one or more functions related to video decoding, such as entropy decoding, inverse quantization, inverse transformation, inter prediction, intra prediction, filtering, as described below in detail.

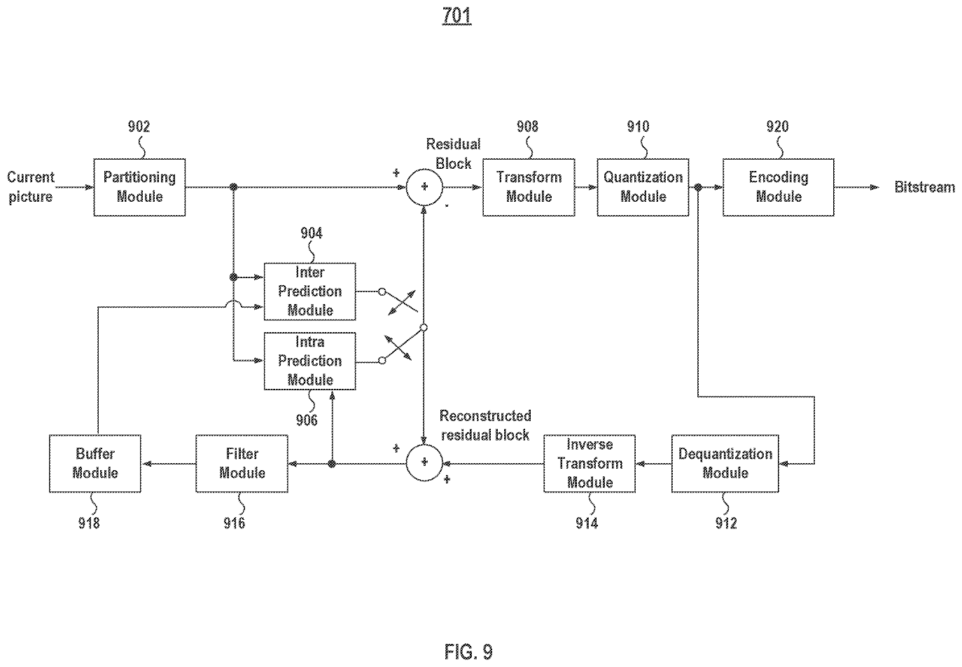

FIG. 9 illustrates a detailed block diagram of exemplary encoder 701 in encoding system 700 in FIG. 7, according to some embodiments of the present disclosure. As shown in FIG. 9, encoder 701 may include a partitioning module 902, an inter prediction module 904, an intra prediction module 906, a transform module 908, a quantization module 910, a dequantization module 912, an inverse transform module 914, a filter module 916, a buffer module 918, and an encoding module 920. It is understood that each of the elements shown in FIG. 9 is independently shown to represent characteristic functions different from each other in a video encoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on encoder 701.

Partitioning module 902 may be configured to partition an input picture of a video into at least one processing unit. A picture can be a frame of the video or a field of the video. In some embodiments, a picture includes an array of luma samples in monochrome format, or an array of luma samples and two corresponding arrays of chroma samples. At this point, the processing unit may be a prediction unit (PU), a transform unit (TU), or a coding unit (CU). Partitioning module 902 may partition a picture into a combination of a plurality of coding units, prediction units, and transform units, and encode a picture by selecting a combination of a coding unit, a prediction unit, and a transform unit based on a predetermined criterion (e.g., a cost function).

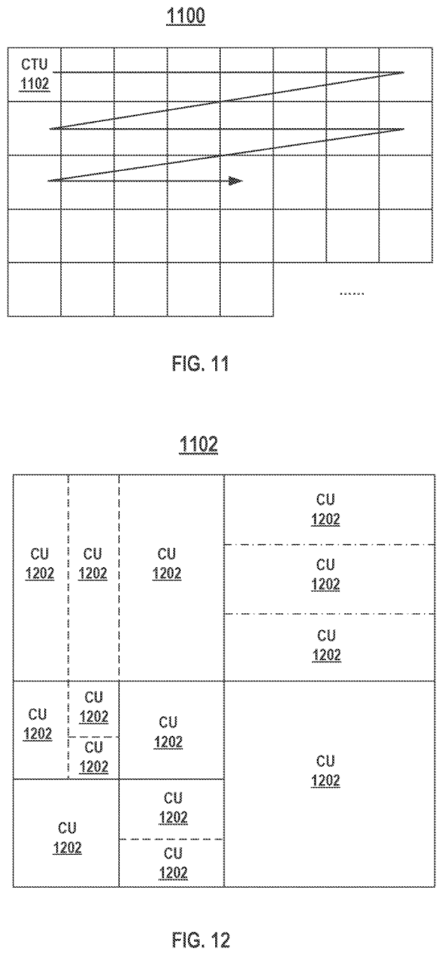

Similar to H.265/HEVC, H.266/VVC is a block-based hybrid spatial and temporal predictive coding scheme. As shown in FIG. 11, during encoding, an input picture 1100 is first divided into square blocks-CTUs 1102, by partitioning module 902. For example, CTUs 1102 can be blocks of 128×128 pixels. As shown in FIG. 12, each CTU 1102 in picture 1100 can be partitioned by partitioning module 902 into one or more CUs 1202, which can be used for prediction and transformation. Unlike H.265/HEVC, in H.266/VVC, CUs 1202 can be rectangular or square, and can be coded without further partitioning into prediction units or transform units. For example, as shown in FIG. 12, the partition of CTU 1102 into CUs 1202 may include quadtree splitting (indicated in solid lines), binary tree splitting (indicated in dashed lines), and ternary splitting (indicated in dash-dotted lines). Each CU 1202 can be as large as its root CTU 1102 or be subdivisions of root CTU 1102 as small as 4×4 blocks, according to some embodiments.

Referring to FIG. 9, inter prediction module 904 may be configured to perform inter prediction on a prediction unit, and intra prediction module 906 may be configured to perform intra prediction on the prediction unit. It may be determined whether to use inter prediction or to perform intra prediction for the prediction unit, and determine specific information (e.g., intra prediction mode, motion vector, reference picture, etc.) according to each prediction method. At this point, a processing unit for performing prediction may be different from a processing unit for determining a prediction method and specific content. For example, a prediction method and a prediction mode may be determined in a prediction unit, and prediction may be performed in a transform unit. Residual coefficients in a residual block between the generated prediction block and the original block may be input into transform module 908. In addition, prediction mode information, motion vector information, and the like used for prediction may be encoded by encoding module 920 together with the residual coefficients or quantization levels into the bitstream. It is understood that in certain encoding modes, an original block may be encoded as it is without generating a prediction block through prediction module 904 or 906. It is also understood that in certain encoding modes, prediction, transform, and/or quantization may be skipped as well.

In some embodiments, inter prediction module 904 may predict a prediction unit based on information on at least one picture among pictures before or after the current picture, and in some cases, it may predict a prediction unit based on information on a partial area that has been encoded in the current picture. Inter prediction module 904 may include sub-modules, such as a reference picture interpolation module, a motion prediction module, and a motion compensation module (not shown). For example, the reference picture interpolation module may receive reference picture information from buffer module 918 and generate pixel information of an integer number of pixels or less from the reference picture. In the case of a luminance pixel, a discrete cosine transform (DCT)-based 8-tap interpolation filter with a varying filter coefficient may be used to generate pixel information of an integer number of pixels or less by the unit of ¼ pixels. In the case of a color difference signal, a DCT-based 4-tap interpolation filter with a varying filter coefficient may be used to generate pixel information of an integer number of pixels or less by the unit of ⅛ pixels. The motion prediction module may perform motion prediction based on the reference picture interpolated by the reference picture interpolation part. Various methods, such as a full search-based block matching algorithm (FBMA), a three-step search (TSS), and a new three-step search algorithm (NTS) may be used as a method of calculating a motion vector. The motion vector may have a motion vector value of a unit of ½, ¼, or 1/16 pixels or integer pel based on interpolated pixels. The motion prediction module may predict a current prediction unit by varying the motion prediction method. Various methods, such as a skip method, a merge method, an advanced motion vector prediction (AMVP) method, an intra-block copy method, and the like, may be used as the motion prediction method.

In some embodiments, intra prediction module 906 may generate a prediction unit based on the information on reference pixels around the current block, which is pixel information in the current picture. The reference pixels may be located in reference lines non-adjacent to the current block. When a block in the neighborhood of the current prediction unit is a block on which inter prediction has been performed and thus, the reference pixel is a pixel on which inter prediction has been performed, the reference pixel included in the block on which inter prediction has been performed may be used in place of reference pixel information of a block in the neighborhood on which intra prediction has been performed. That is, when a reference pixel is unavailable, at least one reference pixel among available reference pixels may be used in place of unavailable reference pixel information. In the intra prediction, the prediction mode may have an angular prediction mode that uses reference pixel information according to a prediction direction, and a non-angular prediction mode that does not use directional information when performing prediction. A mode for predicting luminance information may be different from a mode for predicting color difference information, and intra prediction mode information used to predict luminance information or predicted luminance signal information may be used to predict the color difference information. If the size of the prediction unit is the same as the size of the transform unit when intra prediction is performed, the intra prediction may be performed for the prediction unit based on pixels on the left side, pixels on the top-left side, and pixels on the top of the prediction unit. However, if the size of the prediction unit is different from the size of the transform unit when the intra prediction is performed, the intra prediction may be performed using a reference pixel based on the transform unit.

The intra prediction method may generate a prediction block after applying an adaptive intra smoothing (AIS) filter to the reference pixel according to a prediction mode. The type of the AIS filter applied to the reference pixel may vary. In order to perform the intra prediction method, the intra prediction mode of the current prediction unit may be predicted from the intra prediction mode of the prediction unit existing in the neighborhood of the current prediction unit. When a prediction mode of the current prediction unit is predicted using the mode information predicted from the neighboring prediction unit, if the intra prediction modes of the current prediction unit are the same as the prediction unit in the neighborhood, information indicating that the prediction modes of the current prediction unit is the same as the prediction unit in the neighborhood may be transmitted using predetermined flag information, and if the prediction modes of the current prediction unit and the prediction unit in the neighborhood are different from each other, prediction mode information of the current block may be encoded by extra flags information. Various aspects of the exemplary intra prediction procedure performed by intra prediction module 906 are illustrated in FIGS. 13A-13C.

For example, FIG. 13A illustrates a diagram of a first exemplary intra prediction procedure 1300 that uses a first set of reference lines non-adjacent to the luma CU and a second set of reference lines non-adjacent to the chroma CU, according to some embodiments of the present disclosure. FIG. 13B illustrates a diagram of a second exemplary intra prediction procedure 1325 that uses a first set of reference lines non-adjacent to the luma CU and a second set of reference lines non-adjacent to the chroma CU, according to some embodiments of the present disclosure. FIG. 13C illustrates a diagram of a third exemplary intra prediction procedure 1350 that uses a first set of reference lines non-adjacent to the luma CU and a second set of reference lines non-adjacent to the chroma CU, according to some embodiments of the present disclosure. FIGS. 13A-13C will be described in connection with intra prediction module 906 of FIG. 9.

Referring to FIGS. 9 and 13A, the same reference line for luma MRL intra prediction is applied to CCLM chroma intra prediction by intra prediction module 906 if the tree structure of Y, Cb, and Cr is shared. Otherwise, the reference lines defined by the legacy VVC specification is used for CCLM chroma intra prediction. For instance, assuming that reference line x (e.g., non-adjacent reference line(s) 1301 or reference line 4 in FIG. 13A) is used for luma intra prediction and is specified by ref_line_idx in MRL, the luma reference line x and line x+1 (e.g., non-adjacent reference line(s) 1303 or reference lines 4 and 5 in FIG. 13A) and the chroma sample line floor ((x+1)/2) (e.g., non-adjacent reference line(s) 1305 or reference line 2 in FIG. 13A), where function floor (x) represents the integer part of x, will be used for CCLM intra prediction. The exemplary intra prediction procedure 1300 depicted in FIG. 13A does not need any change to the syntax elements sent in the bitstream to the decoder. Only some modification to the encoding and the decoding process is needed intra prediction module 906.

Depending on applications, when x is an odd number, chroma line floor ((x−1)/2), instead of chroma line floor ((x+1)/2), along with luma lines x and x+1, can be used in CCLM. As mentioned above, this embodiment may be applied only when the tree structure of Y, Cb, and Cr is shared, e.g., namely, when the value of treeType is not DUAL_TREE_CHROMA. When the tree structure of Y, Cb, and Cr is not shared, that is, the value of treeType is DUAL_TREE_CHROMA, the embodiment depicted in FIG. 13B may be performed.

Referring to FIGS. 9 and 13B, the reference line index for CCLM chroma intra prediction may be transmitted independently from the reference line index for luma MRL intra prediction. For example, assuming that intra_cclm_ref_idx is x, where x is an integer between 0 and N, then neighboring luma sample line x and line x+1 (e.g., non-adjacent reference line(s) 1303 or reference lines 2 and 3 in FIG. 13B) and the chroma sample line floor (x/2+½) (e.g., non-adjacent reference line(s) 1305 or reference line 2 in FIG. 13B), where floor (x) represents the integer part of x, will be used for CCLM intra prediction. The value of intra_cclm_ref_idx is in the CCLM luma sample coordinate (e.g., non-adjacent reference line(s) 1303 or reference lines 2 and 3 in FIG. 13B). Depending on the applications, when x is an odd number, chroma reference line floor (x/2−½), instead of chroma line floor (x/2+½), along with luma sample lines x and x+1, can be used for CCLM intra prediction.

Referring to FIGS. 9 and 13B, encoder 701 may include an exemplary coding_unit( ) syntax element in the bitstream. If the value of cclm_mode_flag is equal to 1, an additional syntax element intra_cclm_ref_idx is transmitted. Examples of the exemplary coding_unit( ) syntax element(s) generated by intra prediction module 906 are shown below in Table 5.

TABLE 5
Exemplary coding_unit( ) syntax element

| | Descriptor |
|---|---|
| coding_unit( x0, y0, cbWidth, cbHeight, cqtDepth, treeType, modeType ) { | |
| ... | |
| if( CclmEnabled ) | |
| cclm_mode_flag | ae(v) |
| if( cclm_mode_flag ){ | |
| cclm_mode_idx | ae(v) |
| intra_cclm_ref_idx | ae(v) |
| } | |
| else | |
| intra_chroma_pred_mode | ae(v) |
| ... | |
| } | |

The intra_cclm_ref_idx syntax element (e.g., generated by intra prediction module 906) specifies the reference line used for CCLM chroma intra prediction. The value of intra_cclm_ref_idx is specified with the luma sample coordinate (e.g., non-adjacent reference line 1301 or reference line 4 in FIG. 13B). The neighboring luma sample lines, intra_cclm_ref_idx, intra_cclm_ref_idx+1, and the chroma sample line prediction. When floor (intra_cclm_ref_idx/2+½) may be used for CCLM intra intra_cclm_ref_idx is not present, the value is inferred to be equal to 0.

If the intra_cclm_ref_idx is an even number, the neighboring luma sample lines intra_cclm_ref_idx, intra_cclm_ref_idx+1, and the chroma sample line floor (intra_cclm_ref_idx/2+½) are used for CCLM intra prediction. If the intra_cclm_ref_idx is an odd number, the neighboring luma sample lines, intra_cclm_ref_idx, intra_cclm_ref_idx+1, and the chroma sample line floor (intra_cclm_ref_idx/2−½) are used for CCLM intra prediction. When intra_cclm_ref_idx is not present, the value is inferred to be equal to 0. The embodiment illustrated in FIG. 13B may be applied even if the tree structure of Y, Cb, and Cr is not shared. e.g., namely, even if the value of treeType is set to indicate DUAL_TREE_CHROMA.

Referring to FIGS. 9 and 13C, if the tree structure of Y, Cb and Cr is shared, the difference (a delta value) between the reference line index for CCLM chroma intra prediction and the reference line index for luma MRL intra prediction is transmitted instead of the corresponding reference line indices. The difference between the exemplary embodiments depicted in FIGS. 13B and 13C is that, also with the embodiment of FIG. 13A, the reference line (e.g., non-adjacent reference line(s) 1305 or reference line 1 in FIG. 13C) for CCLM can be indicated independently from the reference line index for luma MRL (e.g., non-adjacent reference line(s) 1301 or reference line 4 in FIG. 13C). However, instead of transmitting the index of the reference line for CCLM itself, only the delta from the index of luma MRL reference line is transmitted. The values of intra_cclm_ref_idx and delta_intra_cclm_ref_idx are in the luma sample coordinate, as in FIG. 13C. The value of intra_cclm_ref_dx may be calculated by intra prediction module 906 according to expression (7).

$$intra\_cclm \_ref \_idx = intra\_luma \_ref \_idx + delta\_intra \_cclm \_ref \_idx . \qquad ( 7 )$$

According to expression (7) and using the example reference lines depicted in FIG. 13C, the value of intra_luma_ref_idx and delta_intra_cclm_ref_idx is 4 and −2, respectively. The value of cclm_luma_ref_line may be calculated as 4+(−2)=2, which indicates that the luma sample lines of cclm_luma_ref_line (e.g., non-adjacent reference line(s) 1303 or reference line 2 in FIG. 13C) and cclm_luma_ref_line+1 (e.g., non-adjacent reference line(s) 1303 or reference line 3) and the chroma sample line floor (cclm_luma_ref_line/2+½) (e.g., non-adjacent reference line(s) 1305 or reference line 1) will be used for CCLM chroma intra prediction.

As in the embodiment depicted in FIG. 13B, depending on applications, when cclm_luma_ref_line is an odd number, chroma sample line floor (cclm_luma_ref_line/2−½), along with luma reference lines cclm_luma_ref_line and cclm_luma_ref_line+1, also can be used in CCLM chroma intra prediction in the embodiment of FIG. 13C.

The embodiment described in connection with FIG. 13C may be applied only when the tree structure of Y, Cb, and Cr is shared, e.g., namely, when the value of treeType is not equal to DUAL_TREE_CHROMA. If the tree structure of Y, Cb, and Cr is not shared, that is, the value of treeType is equal to DUAL_TREE_CHROMA, there are two possible embodiments associated with FIG. 13C. In some embodiments, a coding_unit( ) syntax element shown below in Table 6 are used; however, in some embodiments, the coding_unit( ) syntax element(s) shown below in Table 7 may be used.

TABLE 6
Exemplary coding_unit( ) syntax elements

| | Descriptor |
|---|---|
| coding_unit( x0, y0, cbWidth, cbHeight, cqtDepth, treeType, modeType ) { | |
| ... | |
| if( CclmEnabled ) | |
| cclm_mode_flag | ae(v) |
| if( cclm_mode_flag ){ | |
| cclm_mode_idx | ae(v) |
| if (treeType ! = DUAL_TREE_CHROMA) | |
| delta_intra_cclm_idx_present_flag | ae(v) |
| if( delta_intra_cclm_idx_present_flag) { | |
| abs_delta_intra_cclm_idx | ae(v) |
| delta_intra_cclm_sign_flag | ae(v) |
| } | |
| } | |
| else | |
| intra_chroma_pred_mode | ae(v) |
| ... | |
| } | |

TABLE 7
Exemplary coding_unit( ) syntax elements

| | Descriptor |
|---|---|
| coding_unit( x0, y0, cbWidth, cbHeight, cqtDepth, treeType, modeType ) { | |
| ... | |
| if( CclmEnabled ) | |
| cclm_mode_flag | ae(v) |
| if( cclm_mode_flag ){ | |
| cclm_mode_idx | ae(v) |
| if (treeType ! = DUAL_TREE_CHROMA) | |
| delta_intra_cclm_idx_present_flag | ae(v) |
| if( delta_intra_cclm_idx_present_flag) { | |
| abs_delta_intra_cclm_idx | ae(v) |
| delta_intra_cclm_sign_flag | ae(v) |
| } | |
| else | |
| intra_cclm_ref_idx | ae(v) |
| } | |
| else | |
| intra_chroma_pred_mode | ae(v) |
| ... | |
| } | |

Referring to Table 6 and FIG. 13C, if the tree structure of Y, Cb, and Cr is shared, that is, the value of treeType is not equal to DUAL_TREE_CHROMA, and the value of cclm_mode_flag is 1, an additional syntax element delta_intra_cclm_idx_present_flag may be generated by intra prediction module 906 and transmitted in the bitstream. If the value of delta_intra_cclm_idx_present_flag is 1, additional syntax elements abs_delta_intra_cclm_idx and delta_intra_cclm_sign_flag may be transmitted. If the tree structure of Y, Cb, and Cr is not shared, that is, the value of treeType is equal to DUAL_TREE_CHROMA, the value of delta_intra_cclm_idx_present_flag may be inferred to be equal to 0 by decoder 801, and the method shown in FIG. 13A may be applied. In this case, additional syntax elements abs_delta_intra_cclm_idx and delta_intra_cclm_sign_flag may not be transmitted.

Referring again to Table 6 and FIG. 13C, if the tree structure of Y, Cb, and Cr is shared, that is, the value of treeType is not equal to DUAL_TREE_CHROMA, and the value of cclm_mode_flag is 1, an additional syntax element delta_intra_cclm_idx_present_flag may be generated by intra prediction module 906 and transmitted in the bitstream. If the value of delta_intra_cclm_idx_present_flag is 1, additional syntax elements abs_delta_intra_cclm_idx and delta_intra_cclm_sign_flag are transmitted. If the tree structure of Y, Cb, and Cr is not shared, that is, the value of treeType is equal to DUAL_TREE_CHROMA, instead of the syntax elements abs_delta_intra_cclm_idx and delta_intra_cclm_sign_flag, the syntax element intra_cclm_ref_idx described above in connection with FIG. 13B may be generated and transmitted in the bitstream.

Still referring to Table 6 and FIG. 13C, a delta_intra_cclm_idx_present_flag syntax element equal to 1 indicates that the abs_deta_intra_cclm_idx and delta_intra_cclm_sign_flag are transmitted. A delta_intra_cclm_idx_present_flag value equal to 0 indicates that abs_deta_intra_cclm_idx and delta_intra_cclm_sign_flag are not transmitted, and the value of delta_intra_cclm_idx is 0. In this case the reference lines intra_luma_ref_idx and intra_luma_ref_idx+1 of luma samples and line floor (intra_luma_ref_idx/2+½) of chroma samples will be used for CCLM chroma intra prediction. If the value of treeType is equal to DUAL_TREE_CHROMA, the value of delta_intra_cclm_idx_present_flag may be inferred to be equal to 0 by decoder 801.

Referring again to Table 6 and FIG. 13C, the abs_delta_intra_cclm_idx and delta_intra_cclm_sign_flag indicate the value of the delta_intra_cclm_idx syntax element. A delta_intra_cclm_sign_flag value equal to 0 indicates the delta_intra_cclm_idx is a negative number, and a delta_intra_cclm_sign_flag value equal to 1 indicates the delta_intra_cclm_idx is a positive number. The value of the reference line of luma reference line cclm_luma_ref_line, used for CCLM, is calculated as cclm_luma_ref_line=intra_luma_ref_idx+(2* delta_intra_cclm_sign_flag-1)*delta_intra_cclm_idx. The reference lines cclm_luma_ref_line and cclm_luma_ref_line+1 of luma samples and line floor (cclm_luma_ref_line/2+½) of chroma samples will be used for CCLM chroma intra prediction.

Referring to Table 7 and FIG. 13C, the abs_delta_intra_cclm_idx and delta_intra_cclm_sign_flag indicate the value of delta_intra_cclm_idx. For example, a delta_intra_cclm_sign_flag value equal to 0 indicates the delta_intra_cclm_idx is a negative number, and a delta_intra_cclm_sign_flag value equal to 1 specifies the delta_intra_cclm_idx is a positive number. The value of the reference line of luma reference line cclm_luma_ref_line, used for CCLM, is calculated as cclm_luma_ref_line=intra_luma_ref_idx+(2* delta_intra_cclm_sign_flag-1)*delta_intra_cclm_idx. If cclm_luma_ref_line is an even number, the reference lines cclm_luma_ref_line and celm_luma_ref_line+1 of luma samples and line floor (cclm_luma_ref_line/2+½) of chroma samples may be used for CCLM chroma intra prediction. If the cclm_luma_ref_line is an odd number, the reference lines celm_luma_ref_line and celm_luma_ref_line+1 of luma samples and line floor (cclm_luma_ref_line/2−½) of chroma samples will be used for CCLM chroma intra prediction.

As shown in FIG. 9, a residual block including a prediction unit that has performed prediction based on the prediction unit generated by prediction module 904 or 906 and residual coefficient information, which is a difference value of the prediction unit with the original block, may be generated. The generated residual block may be input into transform module 908.

Transform module 908 may be configured to transform the residual block including the original block and the residual coefficient information of the prediction unit generated through prediction modules 904 and 906 using a transform method, such as DCT, discrete sine transform (DST), Karhunen-Loève transform (KLT), or transform skip. Whether to apply the DCT, the DST, or the KLT to transform the residual block may be determined based on intra prediction mode information of a prediction unit used to generate the residual block. Transform module 908 can transform the video signals in the residual block from the pixel domain to a transform domain (e.g., a frequency domain depending on the transform method). It is understood that in some examples, transform module 908 may be skipped, and the video signals may not be transformed to the transform domain.

Quantization module 910 may be configured to quantize the coefficient of each position in the coding block to generate quantization levels of the positions. The current block may be the residual block. That is, quantization module 910 can perform a quantization process on each residual block. The residual block may include N×M positions (samples) each associated with a transformed or non-transformed video signal/data, such as luma and/or chroma information, where N and M are positive integers. In the present disclosure, before quantization, the transformed or non-transformed video signal at a specific position is referred to herein as a “coefficient.” After quantization, the quantized value of the coefficient is referred to herein as a “quantization level” or “level.”

Quantization can be used to reduce the dynamic range of transformed or non-transformed video signals so that fewer bits will be used to represent video signals. Quantization typically involves division by a quantization step size and subsequent rounding, while dequantization (a.k.a., inverse quantization) involves multiplication by the quantization step size. The quantization step size can be indicated by a quantization parameter (QP). Such a quantization process is referred to as scalar quantization. The quantization of all coefficients within a coding block can be done independently, and this kind of quantization method is used in some existing video compression standards, such as H.264/AVC and H.265/HEVC. The QP in quantization can affect the bit rate used for encoding/decoding the pictures of the video. For example, a higher QP can result in a lower bit rate, and a lower QP can result in a higher bit rate.

For an N×M coding block, a specific coding scan order may be used to convert the two-dimensional (2D) coefficients of a block into a one-dimensional (1D) order for coefficient quantization and coding. Typically, the coding scan starts from the left-top corner and stops at the right-bottom corner of a coding block or the last non-zero coefficient/level in a right-bottom direction. It is understood that the coding scan order may include any suitable order, such as a zig-zag scan order, a vertical (column) scan order, a horizontal (row) scan order, a diagonal scan order, or any combinations thereof. Quantization of a coefficient within a coding block may make use of the coding scan order information. For example, it may depend on the status of the previous quantization level along the coding scan order. In order to further improve the coding efficiency, more than one quantizer, e.g., two scalar quantizers, can be used by quantization module 910. Which quantizer will be used for quantizing the current coefficient may depend on the information preceding the current coefficient in coding scan order. Such a quantization process is referred to as dependent quantization.

Referring to FIG. 9, encoding module 920 may be configured to encode the quantization level of each position in the coding block into the bitstream. In some embodiments, encoding module 920 may perform entropy encoding on the coding block. Entropy encoding may use various binarization methods, such as Golomb-Rice binarization, including, for example, EGk binarization and combined TR and limited EGk binarization, to convert each quantization level into a respective binary representation, such as binary bins. Then, the binary representation can be further compressed using entropy encoding algorithms. The compressed data may be added to the bitstream. Besides the quantization levels, encoding module 920 may encode various other information, such as block type information of a coding unit, prediction mode information, partitioning unit information, prediction unit information, transmission unit information, motion vector information, reference frame information, block interpolation information, and filtering information input from, for example, prediction modules 904 and 906. In some embodiments, encoding module 920 may perform residual coding on a coding block to convert the quantization level into the bitstream. For example, after quantization, there may be N×M quantization levels for an N×M block. These N×M levels may be zero or non-zero values. The non-zero levels may be further binarized to binary bins if the levels are not binary, for example, using combined TR and limited EGk binarization.

Non-binary syntax elements may be mapped to binary codewords. The bijective mapping between symbols and codewords, for which typically simple structured codes are used, is called binarization. The binary symbols, also called bins, of both binary syntax elements and codewords for non-binary data may be coded using binary arithmetic coding. The core coding engine of CABAC can support two operating modes: a context coding mode, in which the bins are coded with adaptive probability models, and a less complex bypass mode that uses fixed probabilities of ½. The adaptive probability models are also called contexts, and the assignment of probability models to individual bins is referred to as context modeling.

As shown in FIG. 9 dequantization module 912 may be configured to dequantize the quantization levels and inverse transform module 914 may be configured to inversely transform the coefficients transformed by transform module 908. The reconstructed residual block generated by dequantization module 912 and inverse transform module 914 may be combined with the prediction units predicted through prediction module 904 or 906 to generate a reconstructed block.

Filter module 916 may include at least one among a deblocking filter, a sample adaptive offset (SAO), and an adaptive loop filter (ALF). The deblocking filter may remove block distortion generated by the boundary between blocks in the reconstructed picture. The SAO module may correct an offset to the original video by the unit of pixel for a video on which the deblocking has been performed. ALF may be performed based on a value obtained by comparing the reconstructed and filtered video and the original video. Buffer module 918 may be configured to store the reconstructed block or picture calculated through filter module 916, and the reconstructed and stored block or picture may be provided to inter prediction module 904 when inter prediction is performed.

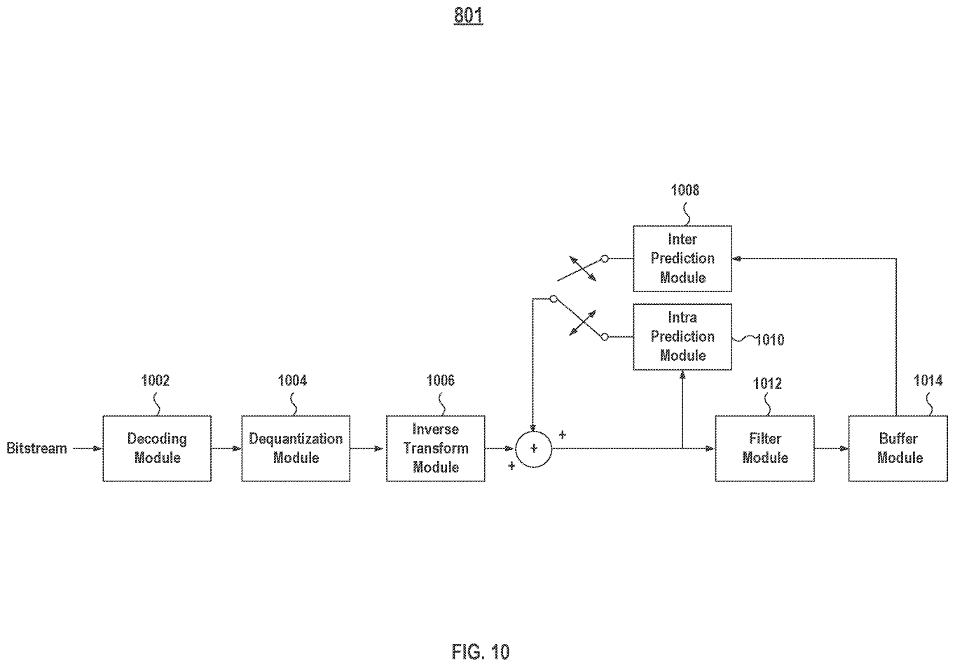

FIG. 10 illustrates a detailed block diagram of exemplary decoder 801 in decoding system 800 in FIG. 8, according to some embodiments of the present disclosure. As shown in FIG. 10, decoder 801 may include a decoding module 1002, a dequantization module 1004, an inverse transform module 1006, an inter prediction module 1008, an intra prediction module 1010, a filter module 1012, and a buffer module 1014. It is understood that each of the elements shown in FIG. 10 is independently shown to represent characteristic functions different from each other in a video decoder, and it does not mean that each component is formed by the configuration unit of separate hardware or single software. That is, each element is included to be listed as an element for convenience of explanation, and at least two of the elements may be combined to form a single element, or one element may be divided into a plurality of elements to perform a function. It is also understood that some of the elements are not necessary elements that perform functions described in the present disclosure but instead may be optional elements for improving performance. It is further understood that these elements may be implemented using electronic hardware, firmware, computer software, or any combination thereof. Whether such elements are implemented as hardware, firmware, or software depends upon the particular application and design constraints imposed on decoder 801.

When a video bitstream is input from a video encoder (e.g., encoder 701), the input bitstream may be decoded by decoder 801 in a procedure opposite to that of the video encoder. Thus, some details of decoding that are described above with respect to encoding may be skipped for case of description. Decoding module 1002 may be configured to decode the bitstream to obtain various information encoded into the bitstream, such as the quantization level of each position in the coding block. In some embodiments, decoding module 1002 may perform entropy decoding (decompressing) corresponding to the entropy encoding (compressing) performed by the encoder, such as, for example, VLC, CAVLC, CABAC, SBAC, PIPE coding, and the like to obtain the binary representation (e.g., binary bins). Decoding module 1002 may further convert the binary representations to quantization levels using Golomb-Rice binarization, including, for example, EGk binarization and combined TR and limited EGk binarization. Besides the quantization levels of the positions in the transform units, decoding module 1002 may decode various other information, such as the parameters used for Golomb-Rice binarization (e.g., the Rice parameter), block type information of a coding unit, prediction mode information, partitioning unit information, prediction unit information, transmission unit information, motion vector information, reference frame information, block interpolation information, and filtering information. During the decoding process, decoding module 1002 may perform rearrangement on the bitstream to reconstruct and rearrange the data from a 1D order into a 2D rearranged block through a method of inverse-scanning based on the coding scan order used by the encoder.

Dequantization module 1004 may be configured to dequantize the quantization level of each position of the coding block (e.g., the 2D reconstructed block) to obtain the coefficient of each position. In some embodiments, dequantization module 1004 may perform dependent dequantization based on quantization parameters provided by the encoder as well, including the information related to the quantizers used in dependent quantization, for example, the quantization step size used by each quantizer.

Inverse transform module 1006 may be configured to perform inverse transformation, for example, inverse DCT, inverse DST, and inverse KLT, for DCT, DST, and KLT performed by the encoder, respectively, to transform the data from the transform domain (e.g., coefficients) back to the pixel domain (e.g., luma and/or chroma information). In some embodiments, inverse transform module 1006 may selectively perform a transform operation (e.g., DCT, DST, KLT) according to a plurality of pieces of information such as a prediction method, a size of the current block, a prediction direction, and the like.

Inter prediction module 1008 and intra prediction module 1010 may be configured to generate a prediction block based on information related to the generation of a prediction block provided by decoding module 1002 and information of a previously decoded block or picture provided by buffer module 1014. As described above, if the size of the prediction unit and the size of the transform unit are the same when intra prediction is performed in the same manner as the operation of the encoder, intra prediction may be performed on the prediction unit based on the pixel existing on the left side, the pixel on the top-left side, and the pixel on the top of the prediction unit. However, if the size of the prediction unit and the size of the transform unit are different when intra prediction is performed, intra prediction may be performed using a reference pixel based on a transform unit.

Intra prediction module 1010 may be configured to receive a bitstream that includes a set of luma pixel values associated with a luma CU and a set of chroma pixel values associated with a chroma CU from encoder 701. In some embodiments, intra prediction module 1010 may be configured to identify information associated with a luma reference line index associated with the first set of reference lines non-adjacent to the luma CU from the bitstream or information associated with a chroma reference line index associated with the second set of reference lines non-adjacent to the chroma CU. The indication may be identified as one or more of the indications and/or syntax elements described above in connection with FIGS. 13A-13C. In some embodiments, intra prediction module 1010 may be configured to identify a correlation function associated with a first set of reference lines non-adjacent to the luma CU and used to generate the set of luma pixel values by the image encoder and a second set of reference lines non-adjacent to the chroma CU and used to generate the set of chroma pixel values by the image encoder. In some embodiments, intra prediction module 1010 may be configured to decode the bitstream based on the correlation function to identify the set of luma pixel values associated with the luma CU and the set of chroma pixel values associated with the chroma CU.

The reconstructed block or reconstructed picture combined from the outputs of inverse transform module 1006 and prediction module 1008 or 1010 may be provided to filter module 1012. Filter module 1012 may include a deblocking filter, an offset correction module, and an ALF. Buffer module 1014 may store the reconstructed picture or block and use it as a reference picture or a reference block for inter prediction module 1008 and may output the reconstructed picture.

Consistent with the scope of the present disclosure, encoding module 920 and decoding module 1002 may be configured to adopt a scheme of quantization level binarization with Rice parameter adapted to the bit depth and/or the bit rate for encoding the picture of the video to improve the coding efficiency.

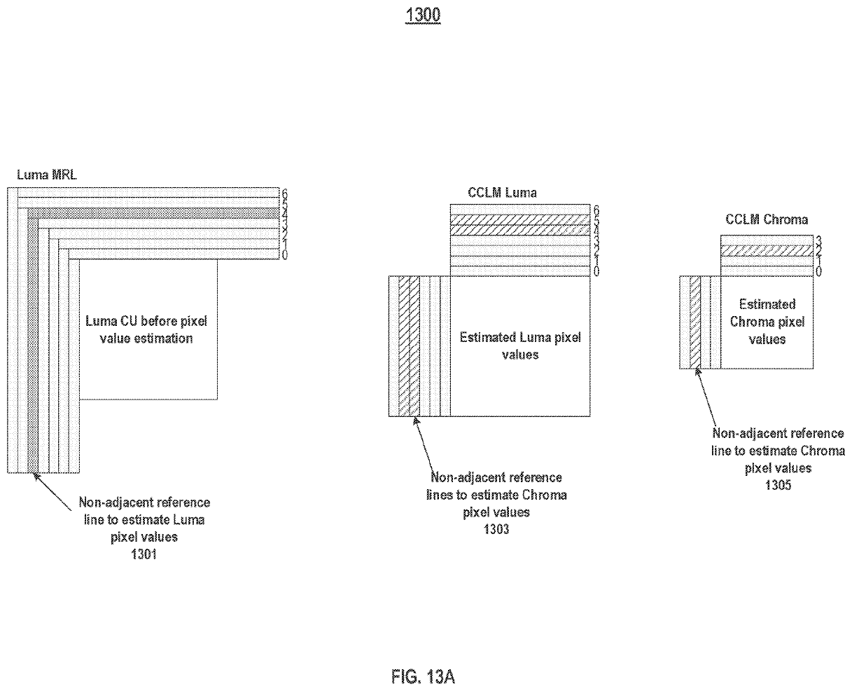

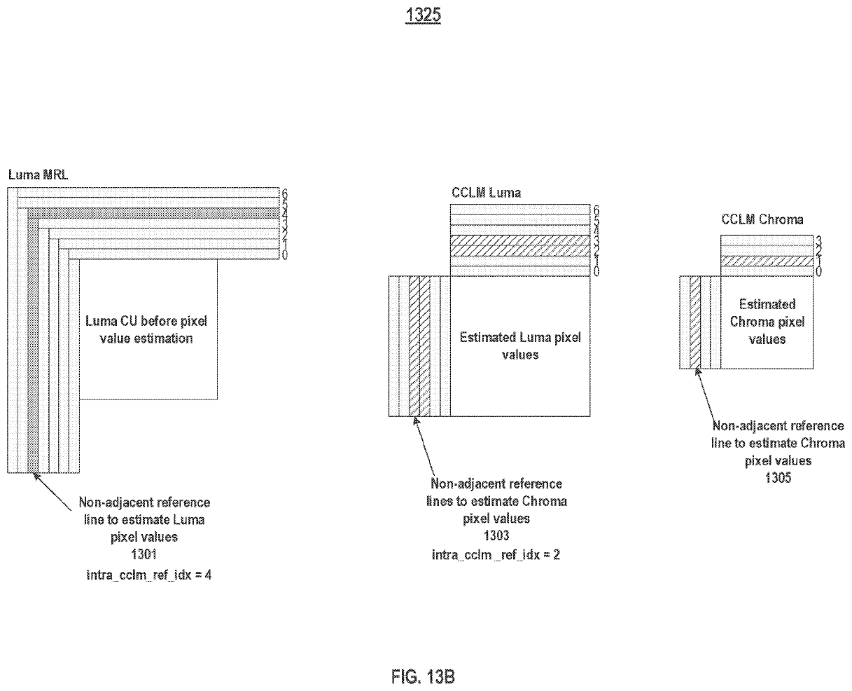

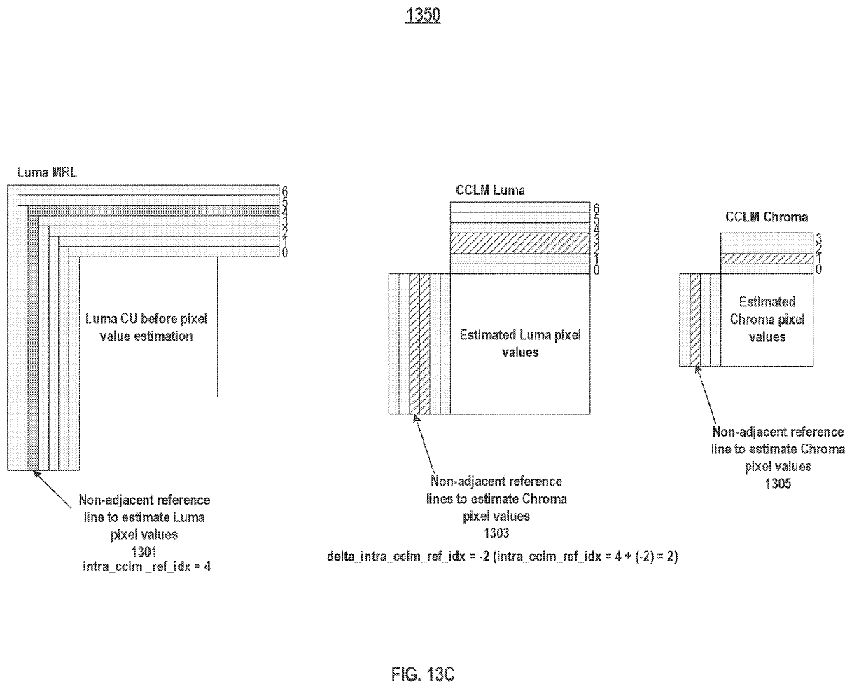

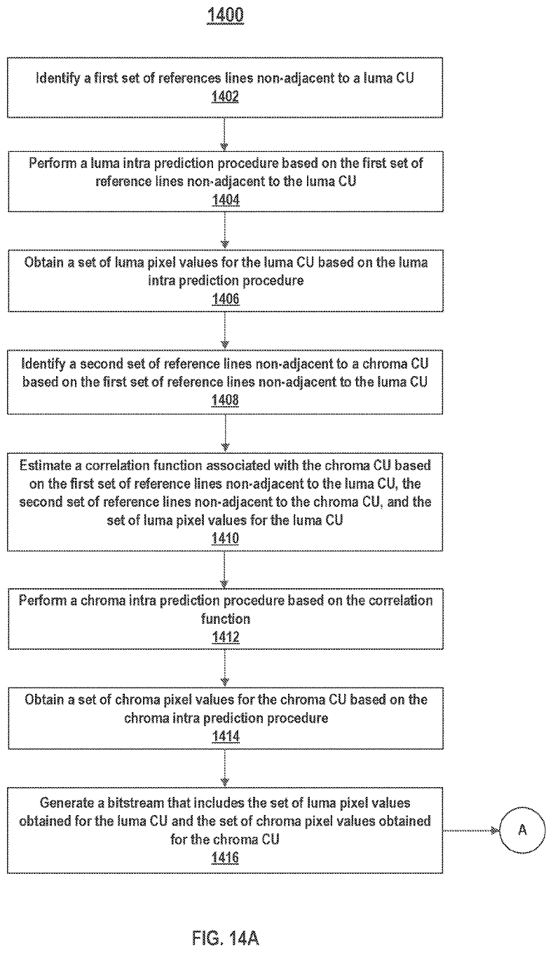

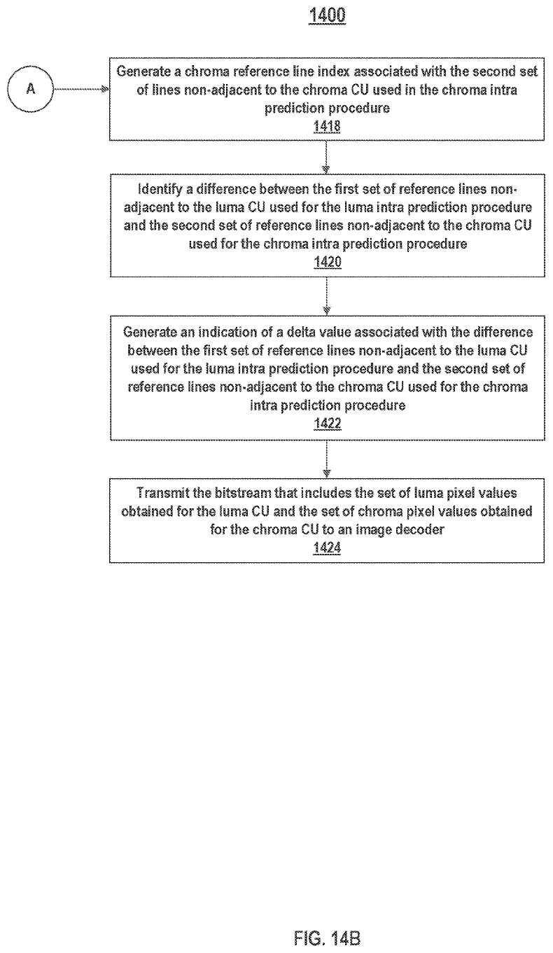

FIGS. 14A and 14B illustrate a flowchart of an exemplary method 1400 of video encoding, according to some embodiments of the present disclosure. Method 1400 may be performed by a system, e.g., such as encoding system 700, encoder 701, or intra prediction module 906, just to name a few. Method 1400 may include operations 1402-1424 as described below. It is to be appreciated that some of the steps may be optional, and some of the steps may be performed simultaneously, or in a different order than shown in FIGS. 14A and 14B.

Referring to FIG. 14A, at 1402, the apparatus may identify a first set of reference lines non-adjacent to a luma CU. For example, referring to FIGS. 9 and 13A-13C, intra prediction module 906 may identify a first set of reference lines non-adjacent (e.g., non-adjacent reference line(s) 1301) to the luma CU for MRL. In the examples illustrated in FIGS. 13A-13C, the first set of reference lines non-adjacent to the luma CU may include, e.g., reference line 4. The non-adjacent reference lines may include any reference line that is not directly neighboring the luma CU. In other words, any reference line other than reference line 0 may be selected for luma CU. In some cases, the reference line with the least about of noise may be selected for luma intra prediction.

At 1404, the apparatus may perform a luma intra prediction procedure based on the first set of reference lines non-adjacent to the luma CU. For example, referring to FIGS. 13A-13C, reference line 4 may be used for luma intra prediction (e.g., MRL).

At 1406, the apparatus may obtain a set of luma pixel values for the luma CU based on the luma intra prediction procedure. For example, referring to FIGS. 9 and 13A-13C, intra prediction module 906 may obtain a set of luma pixel values for the luma CU by applying MRL to the first set of reference lines.

At 1408, the apparatus may identify a second set of reference lines non-adjacent to a chroma CU based on the first set of reference lines non-adjacent to the luma CU. For example, referring to FIGS. 9 and 13A-13C, intra prediction module 906 may identify a second set of reference lines (e.g., non-adjacent reference line(s) 1305 in FIGS. 13A-13C) non-adjacent to the chroma CU based on the first set of reference lines. The second set of reference line(s) may be identified based on the operations described above in connection with FIGS. 13A-13C.

At 1410, the apparatus may estimate a correlation function associated with the chroma CU based on the first set of reference lines non-adjacent to the luma CU, the second set of reference lines non-adjacent to the chroma CU, and the set of luma pixel values for the luma CU. For example, referring to FIGS. 9 and 13A-13C, intra prediction module 906 may identify offsets a′ and b′ according to the operations described above in connection with FIGS. 4 and 13A-13C.

At 1412, the apparatus may perform a chroma intra prediction procedure based on the correlation function. For example, referring to FIGS. 9 and 13A-13C, intra prediction module 906 may perform chroma intra prediction based on one or more of the first set of reference lines, the second set of reference lines, the correlation function, and/or the pixel values estimated for the luma CU.

At 1414, the apparatus may obtain a set of chroma pixel values for the chroma CU based on the chroma intra prediction procedure. For example, referring to FIGS. 9 and 13A-13C, intra prediction module 906 may obtain the set of chroma pixel values for the chroma CU based on the chroma intra prediction procedure performed based on one or more of the first set of reference lines, the second set of reference lines, the correlation function, and/or the pixel values estimated for the luma CU.

At 1416, the apparatus may generate a bitstream that includes the set of luma pixel values obtained for the luma CU and the set of chroma pixel values obtained for the chroma CU. For example, referring to FIG. 9, encoder 701 may generate a bitstream that is output by encoding module 920.

Referring to FIG. 14B, at 1418, the apparatus may generate a chroma reference line index associated with the second set of reference lines non-adjacent to the chroma CU used in the chroma intra prediction procedure. For example, referring to FIGS. 9, 13B, and 13C, intra prediction module 906 may generate intra_cclm_ref_idx, which is associated with the second set of reference lines non-adjacent to the chroma CU.

At 1420, the apparatus may identify a difference between the first set of reference lines non-adjacent to the luma CU used for the luma intra prediction procedure and the second set of reference lines non-adjacent to the chroma CU used for the chroma intra prediction procedure. For example, referring to FIGS. 9 and 13C, if the tree structure of Y, Cb, and Cr is shared, the difference (a delta value) between the reference line index for CCLM chroma intra prediction and the reference line index for luma MRL intra prediction is transmitted instead of the corresponding reference line indices.

At 1422, the apparatus may generate an indication of a delta value associated with the difference between the first set of reference lines non-adjacent to the luma CU used for the luma intra prediction procedure and the second set of reference lines non-adjacent to the chroma CU used for the chroma intra prediction procedure. For example, referring to FIGS. 9 and 13C, the reference line (e.g., non-adjacent reference line(s) 1305 or reference line 1 in FIG. 13C) for CCLM can be indicated independently from the reference line index for luma MRL (e.g., non-adjacent reference line(s) 1301 or reference line 4 in FIG. 13C). However, instead of transmitting the index of the reference line for CCLM itself, only the delta from the index of luma MRL reference line is transmitted. The values of intra_cclm_ref_idx and delta_intra_cclm_ref_idx are in the luma sample coordinate, as in FIG. 13B. The value of intra_cclm_ref_dx may be calculated by intra prediction module 906 according to expression (7).

At 1424, the apparatus may transmit the bitstream that includes the set of luma pixel values obtained for the luma CU and the set of chroma pixel values obtained for the chroma CU to an image decoder. For example, referring to FIGS. 9 and 13C, encoder 701 may transmit a bitstream that includes the set of luma pixel values obtained for the luma CU and the set of chroma pixel values obtained for the chroma CU to decoder 801.

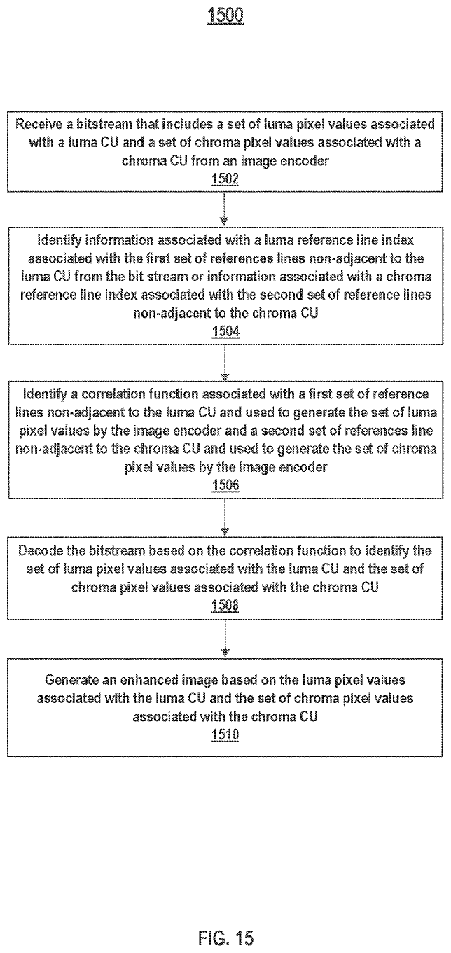

FIG. 15 illustrates a flowchart of an exemplary method 1500 of video decoding, according to some embodiments of the present disclosure. Method 1500 may be performed by a system, e.g., such as decoding system 800, decoder 801, or intra prediction module 1010, just to name a few. Method 1500 may include operations 1502-1510, as described below. It is to be appreciated that some of the steps may be optional, and some of the steps may be performed simultaneously, or in a different order than shown in FIG. 15.

Referring to FIG. 15, at 1502, the apparatus may receive a bitstream that includes a set of luma pixel values associated with a luma CU and a set of chroma pixel values associated with a chroma CU from an image encoder. For example, referring to FIGS. 9 and 10, decoder 801 may receive a bitstream from encoder 701.

At 1504, the apparatus may identify information associated with a luma reference line index associated with the first set of reference lines non-adjacent to the luma CU from the bitstream or information associated with a chroma reference line index associated with the second set of reference lines non-adjacent to the chroma CU. For example, referring to FIG. 10, intra prediction module 1010 may be configured to identify information associated with a luma reference line index associated with the first set of reference lines non-adjacent to the luma CU from the bitstream or information associated with a chroma reference line index associated with the second set of reference lines non-adjacent to the chroma CU. The indication may be identified as one or more of the indications and/or syntax elements described above in connection with FIGS. 13A-13C.

At 1506, the apparatus may identify a correlation function associated with a first set of reference lines non-adjacent to the luma CU and used to generate the set of luma pixel values by the image encoder and a second set of reference lines non-adjacent to the chroma CU and used to generate the set of chroma pixel values by the image encoder. For example, referring to FIG. 10, intra prediction module 1010 may be configured to identify a correlation function associated with a first set of reference lines non-adjacent to the luma CU and used to generate the set of luma pixel values by the image encoder and a second set of reference lines non-adjacent to the chroma CU and used to generate the set of chroma pixel values by the image encoder.

At 1508, the apparatus may decode the bitstream based on the correlation function to identify the set of luma pixel values associated with the luma CU and the set of chroma pixel values associated with the chroma CU. For example, referring to FIG. 10, intra prediction module 1010 may be configured to decode the bitstream based on the correlation function to identify the set of luma pixel values associated with the luma CU and the set of chroma pixel values associated with the chroma CU.

At 1510, the apparatus may generate an enhanced image based on the set of luma pixel values associated with the luma CU and the set of chroma pixel values associated with the chroma CU. For example, referring to FIG. 10, decoder 801 may be configured to generate an enhanced image based on the luma pixel values and the chroma pixel values obtained based on the operations described above in connection with FIGS. 13A-13C.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 702 in FIGS. 7 and 8. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of encoding by an encoder is provided. The method may include identifying, by at least one processor, a first set of reference lines non-adjacent to a luma CU. The method may include performing, by the at least one processor, a luma intra prediction procedure based on the first set of reference lines non-adjacent to the luma CU. The method may include obtaining, by the at least one processor, a set of luma pixel values for the luma CU based on the luma intra prediction procedure. The method may include identifying, by the at least one processor, a second set of reference lines non-adjacent to a chroma CU based on the first set of reference lines non-adjacent to the luma CU. The method may include estimating, by the at least one processor, a correlation function associated with the chroma CU based on the first set of reference lines non-adjacent to the luma CU, the second set of reference lines non-adjacent to the chroma CU, and the set of luma pixel values for the luma CU.

In some embodiments, the method may include performing, by the at least one processor, a chroma intra prediction procedure based on the correlation function. In some embodiments, the method may include obtaining, by the at least one processor, a set of chroma pixel values for the chroma CU based on the chroma intra prediction procedure. In some embodiments, the method may include generating, by the at least one processor, a bitstream that includes the set of luma pixel values obtained for the luma CU and the set of chroma pixel values obtained for the chroma CU. In some embodiments, the method may include transmitting, by a communication interface, the bitstream that includes the set of luma pixel values obtained for the luma CU and the set of chroma pixel values obtained for the chroma CU to an image decoder.

In some embodiments, the luma intra prediction procedure may include an MRL intra prediction procedure. In some embodiments, the chroma intra prediction procedure may include a CCLM procedure.

In some embodiments, the method may include generating, by the at least one processor, a luma reference line index associated with the first set of reference lines non-adjacent to the luma CU used in the luma intra prediction procedure. In some embodiments, the bitstream may be further generated to include the luma reference line index.

In some embodiments, a luma reference line index value associated with the first set of references lines non-adjacent to the luma CU used in the luma intra prediction procedure and a chroma reference line index value associated with the second set of reference lines non-adjacent to the chroma CU used in the chroma intra prediction procedure may be a same value.

In some embodiments, the second set of reference lines non-adjacent to the chroma CU used for the chroma intra prediction procedure include the first set of reference lines non-adjacent to the luma CU used for the luma intra prediction procedure and a reference line located above the first set of reference lines non-adjacent to the luma CU.

In some embodiments, the second set of reference lines non-adjacent to the chroma CU used for the chroma intra prediction procedure include the first set of reference lines non-adjacent to the luma CU used for the luma intra prediction procedure and a reference line located below the first set of reference lines non-adjacent to the luma CU.

In some embodiments, the method may include generating, by the at least one processor, a chroma reference line index associated with the second set of reference lines non-adjacent to the chroma CU used in the chroma intra prediction procedure. In some embodiments, the bitstream may be further generated to include the chroma reference line index.

In some embodiments, a luma reference line index value associated with the first set of references lines non-adjacent to the luma CU used in the luma intra prediction procedure and the chroma reference line index value associated with the second set of reference lines non-adjacent to the chroma CU may be different values.

In some embodiments, the method may include identifying, by the at least one processor, a difference between the first set of reference lines non-adjacent to the luma CU used for the luma intra prediction procedure and the second set of reference lines non-adjacent to the chroma CU used for the chroma intra prediction procedure. In some embodiments, the method may include generating, by the at least one processor, an indication of a delta value associated with the difference between the first set of reference lines non-adjacent to the luma CU used for the luma intra prediction procedure and the second set of reference lines non-adjacent to the chroma CU used for the chroma intra prediction procedure. In some embodiments, the bitstream may be further generated to include the indication of the delta value associated with the difference between first set of reference lines non-adjacent to the luma CU used for the luma intra prediction procedure and the second set of reference lines non-adjacent to the chroma CU used for the chroma intra prediction procedure.

In some embodiments, a coding tree structure associated with the luma CU and

the chroma CU may be the same.

In some embodiments, the indication may include a bit set to a first value to indicate a negative delta value. In some embodiments, the indication may include a bit set to a second value different than the first value to indicate a positive delta value.

In some embodiments, the indication may include the delta value.

In some embodiments, the indication may not include the delta value.

According to another aspect of the present disclosure, a system for encoding by an encoder is provided. The system may include at least one processor and memory storing instructions. The memory storing instructions, which when executed by the at least one processor, may cause the at least one processor to identify a first set of reference lines non-adjacent to a luma CU. The memory storing instructions, which when executed by the at least one processor, may cause the at least one processor to perform a luma intra prediction procedure based on the first set of reference lines non-adjacent to the luma CU. The memory storing instructions, which when executed by the at least one processor, may cause the at least one processor to obtain a set of luma pixel values for the luma CU based on the luma intra prediction procedure. The memory storing instructions, which when executed by the at least one processor, may cause the at least one processor to identify a second set of reference lines non-adjacent to a chroma CU based on the first set of reference lines non-adjacent to the luma CU. The memory storing instructions, which when executed by the at least one processor, may cause the at least one processor to estimate a correlation function associated with the chroma CU based on the first set of reference lines non-adjacent to the luma CU, the second set of reference lines non-adjacent to the chroma CU, and the set of luma pixel values for the luma CU.

In some embodiments, the memory storing instructions, which when executed by the at least one processor, may further cause the at least one processor to perform a chroma intra prediction procedure based on the correlation function. In some embodiments, the memory storing instructions, which when executed by the at least one processor, may further cause the at least one processor to obtain a set of chroma pixel values for the chroma CU based on the chroma intra prediction procedure. In some embodiments, the memory storing instructions, which when executed by the at least one processor, may further cause the at least one processor to generate a bitstream that includes the set of luma pixel values obtained for the luma CU and the set of chroma pixel values obtained for the chroma CU. In some embodiments, the memory storing instructions, which when executed by the at least one processor, may further cause the at least one processor to transmit the bitstream that includes the set of luma pixel values obtained for the luma CU and the set of chroma pixel values obtained for the chroma CU to an image decoder.

In some embodiments, the luma intra prediction procedure may include an MRL intra prediction procedure. In some embodiments, the chroma intra prediction procedure may include a CCLM procedure.

In some embodiments, the memory storing instructions, which when executed by the at least one processor, may further cause the at least one processor to generate a luma reference line index associated with the first set of references lines non-adjacent to the luma CU used in the luma intra prediction procedure. In some embodiments, the bitstream may be further generated to include the luma reference line index.

In some embodiments, a luma reference line index value associated with the first set of references lines non-adjacent to the luma CU used in the luma intra prediction procedure and a chroma reference line index value associated with the second set of reference lines non-adjacent to the chroma CU used in the chroma intra prediction procedure may be a same value.

In some embodiments, the second set of reference lines non-adjacent to the chroma CU used for the chroma intra prediction procedure may include the first set of reference lines non-adjacent to the luma CU used for the luma intra prediction procedure and a reference line located above the first set of reference lines non-adjacent to the luma CU.

In some embodiments, the second set of reference lines non-adjacent to the chroma CU used for the chroma intra prediction procedure may include the first set of reference lines non-adjacent to the luma CU used for the luma intra prediction procedure and a reference line located below the first set of reference lines non-adjacent to the luma CU.

In some embodiments, the memory storing instructions, which when executed by the at least one processor, may further cause the at least one processor to generate a chroma reference line index associated with the second set of reference lines non-adjacent to the chroma CU used in the chroma intra prediction procedure. In some embodiments, the bitstream may be further generated to include the chroma reference line index.

In some embodiments, a luma reference line index value associated with the first set of references lines non-adjacent to the luma CU used in the luma intra prediction procedure and the chroma reference line index value associated with the second set of reference lines non-adjacent to the chroma CU may be different values.

In some embodiments, the memory storing instructions, which when executed by the at least one processor, may further cause the at least one processor to identify a difference between the first set of reference lines non-adjacent to the luma CU used for the luma intra prediction procedure and the second set of reference lines non-adjacent to the chroma CU used for the chroma intra prediction procedure. In some embodiments, the memory storing instructions, which when executed by the at least one processor, may further cause the at least one processor to generate an indication of a delta value associated with the difference between the first set of reference lines non-adjacent to the luma CU used for the luma intra prediction procedure and the second set of reference lines non-adjacent to the chroma CU used for the chroma intra prediction procedure. In some embodiments, the bitstream may be further generated to include the indication of the delta value associated with the difference between first set of reference lines non-adjacent to the luma CU used for the luma intra prediction procedure and the second set of reference lines non-adjacent to the chroma CU used for the chroma intra prediction procedure.

In some embodiments, a coding tree structure associated with the luma CU and the chroma CU may be the same.

In some embodiments, the indication may include a bit set to a first value to indicate a negative delta value. In some embodiments, the indication may include bit set to a second value different than the first value to indicate a positive delta value.

In some embodiments, the indication may include the delta value.

In some embodiments, the indication may not include the delta value.

According to a further aspect of the present disclosure, a method of decoding by a decoder is provided. The method may include receiving, by a communication interface, a bitstream that includes a set of luma pixel values associated with a luma CU and a set of chroma pixel values associated with a chroma CU from an image encoder. The method may include identifying, by at least one processor, a correlation function associated with a first set of reference lines non-adjacent to the luma CU and used to generate the set of luma pixel values by the image encoder and a second set of references line non-adjacent to the chroma CU and used to generate the set of chroma pixel values by the image encoder.

In some embodiments, the method may include decoding, by the at least one processor, the bitstream based on the correlation function to identify the set of luma pixel values associated with the luma CU and the set of chroma pixel values associated with the chroma CU. In some embodiments, the method may include generating, by the at least one processor, an enhanced image based on the set of luma pixel values associated with the luma CU and the set of chroma pixel values associated with the chroma CU.

In some embodiments, the method may include identifying, by the at least one processor, information associated with a luma reference line index associated with the first set of references lines non-adjacent to the luma CU from the bitstream or information associated with a chroma reference line index associated with the second set of reference lines non-adjacent to the chroma CU. In some embodiments, the correlation function may be identified based on the luma reference line index.

In some embodiments, a luma reference line index value associated with the first set of references lines non-adjacent to the luma CU and a chroma reference line index value associated with the second set of reference lines non-adjacent to the chroma CU may be a same value.

In some embodiments, the second set of reference lines non-adjacent to the chroma CU may include the first set of reference lines non-adjacent to the luma CU and a reference line located above the first set of reference lines non-adjacent to the luma CU. In some embodiments, the correlation function may be identified based on the second set of reference lines non-adjacent to the chroma CU that includes the first set of reference lines non-adjacent to the luma CU and the reference line located above the first set of reference lines non-adjacent to the luma CU.

In some embodiments, the second set of reference lines non-adjacent to the chroma CU may include the first set of reference lines non-adjacent to the luma CU and a reference line located below the first set of reference lines non-adjacent to the luma CU. In some embodiments, the correlation function may be identified based on the second set of reference lines non-adjacent to the chroma CU that includes the first set of reference lines non-adjacent to the luma CU and the reference line located below the first set of reference lines non-adjacent to the luma CU.

In some embodiments, the bitstream may further include a chroma reference line index associated with the second set of reference lines non-adjacent to the chroma CU. In some embodiments, the correlation function may be identified based on the chroma reference line index associated with the second set of reference lines non-adjacent to the chroma CU.

In some embodiments, a luma reference line index value associated with the first set of references lines non-adjacent to the luma CU and the chroma reference line index value associated with the second set of reference lines non-adjacent to the chroma CU may be different values.

In some embodiments, the bitstream may further include an indication of a delta value associated with a difference between the first set of reference lines non-adjacent to the luma CU and the second set of reference lines non-adjacent to the chroma CU. In some embodiments, the correlation function may be identified based on the indication of the delta value.

In some embodiments, a coding tree structure associated with the luma CU and the chroma CU may be the same.

In some embodiments, the indication may include a bit set to a first value to indicate a negative delta value. In some embodiments, the indication may include bit set to a second value different than the first value to indicate a positive delta value.

In some embodiments, the indication may include the delta value.

In some embodiments, the indication may not include the delta value.

According to still another aspect of the present disclosure, a system for decoding by n decoder is provided. The system may include at least one processor and memory storing instructions. The memory storing instructions, which when executed by the at least one processor, may cause the at least one processor to receive a bitstream that includes a set of luma pixel values associated with a luma CU and a set of chroma pixel values associated with a chroma CU from an image encoder. The memory storing instructions, which when executed by the at least one processor, may cause the at least one processor to identify a correlation function associated with a first set of reference lines non-adjacent to the luma CU and used to generate the set of luma pixel values by the image encoder and a second set of references line non-adjacent to the chroma CU and used to generate the set of chroma pixel values by the image encoder.

In some embodiments, the memory storing instructions, which when executed by the at least one processor, may further cause the at least one processor to decode the bitstream based on the correlation function to identify the set of luma pixel values associated with the luma CU and the set of chroma pixel values associated with the chroma CU. In some embodiments, the memory storing instructions, which when executed by the at least one processor, may further cause the at least one processor to generate an enhanced image based on the set of luma pixel values associated with the luma CU and the set of chroma pixel values associated with the chroma CU.

In some embodiments, the memory storing instructions, which when executed by the at least one processor, may further cause the at least one processor to identify information associated with a luma reference line index associated with the first set of references lines non-adjacent to the luma CU from the bitstream or information associated with a chroma reference line index associated with the second set of reference lines non-adjacent to the chroma CU. In some embodiments, the correlation function may be identified based on the luma reference line index.

In some embodiments, a luma reference line index value associated with the first set of references lines non-adjacent to the luma CU and a chroma reference line index value associated with the second set of reference lines non-adjacent to the chroma CU may be a same value.

In some embodiments, the second set of reference lines non-adjacent to the chroma CU may include the first set of reference lines non-adjacent to the luma CU and a reference line located above the first set of reference lines non-adjacent to the luma CU. In some embodiments, the correlation function may be identified based on the second set of reference lines non-adjacent to the chroma CU that includes the first set of reference lines non-adjacent to the luma CU and the reference line located above the first set of reference lines non-adjacent to the luma CU.

In some embodiments, the second set of reference lines non-adjacent to the chroma CU may include the first set of reference lines non-adjacent to the luma CU and a reference line located below the first set of reference lines non-adjacent to the luma CU. In some embodiments, the correlation function may be identified based on the second set of reference lines non-adjacent to the chroma CU that includes the first set of reference lines non-adjacent to the luma CU and the reference line located below the first set of reference lines non-adjacent to the luma CU.

In some embodiments, the bitstream may further include a chroma reference line index associated with the second set of reference lines non-adjacent to the chroma CU. In some embodiments, the correlation function may be identified based on the chroma reference line index associated with the second set of reference lines non-adjacent to the chroma CU.

In some embodiments, a luma reference line index value associated with the first set of references lines non-adjacent to the luma CU and the chroma reference line index value associated with the second set of reference lines non-adjacent to the chroma CU may be different values.

In some embodiments, the bitstream may further include an indication of a delta value associated with a difference between the first set of reference lines non-adjacent to the luma CU and the second set of reference lines non-adjacent to the chroma CU. In some embodiments, the correlation function may be identified based on the indication of the delta value.

In some embodiments, a coding tree structure associated with the luma CU and the chroma CU may be the same.

In some embodiments, the indication may include a bit set to a first value to indicate a negative delta value. In some embodiments, the indication may include bit set to a second value different than the first value to indicate a positive delta value.

In some embodiments, the indication may include the delta value.

In some embodiments, the indication may not include the delta value.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

1. A method of encoding by an encoder, comprising:
identifying, by at least one processor, a first set of references lines non-adjacent to a luma coding unit (CU);
performing, by the at least one processor, a luma intra prediction procedure based on the first set of reference lines non-adjacent to the luma CU;
obtaining, by the at least one processor, a set of luma pixel values for the luma CU based on the luma intra prediction procedure;
identifying, by the at least one processor, a second set of reference lines non-adjacent to a chroma CU based on the first set of reference lines non-adjacent to the luma CU; and
estimating, by the at least one processor, a correlation function associated with the chroma CU based on the first set of reference lines non-adjacent to the luma CU, the second set of reference lines non-adjacent to the chroma CU, and the set of luma pixel values for the luma CU.

2. The method of claim 1, further comprising:
performing, by the at least one processor, a chroma intra prediction procedure based on the correlation function;
obtaining, by the at least one processor, a set of chroma pixel values for the chroma CU based on the chroma intra prediction procedure;
generating, by the at least one processor, a bitstream that includes the set of luma pixel values obtained for the luma CU and the set of chroma pixel values obtained for the chroma CU; and
transmitting, by a communication interface, the bitstream that includes the set of luma pixel values obtained for the luma CU and the set of chroma pixel values obtained for the chroma CU to an image decoder.

3. (canceled)

4. The method of claim 2, further comprising:
generating, by the at least one processor, a luma reference line index associated with the first set of references lines non-adjacent to the luma CU used in the luma intra prediction procedure,
wherein the bitstream is further generated to include the luma reference line index.

5. The method of claim 4, wherein a luma reference line index value associated with the first set of reference lines non-adjacent to the luma CU used in the luma intra prediction procedure and a chroma reference line index value associated with the second set of reference lines non-adjacent to the chroma CU used in the chroma intra prediction procedure are a same value.

6-7. (canceled)

8. The method of claim 2, further comprising:
generating, by the at least one processor, a chroma reference line index associated with the second set of reference lines non-adjacent to the chroma CU used in the chroma intra prediction procedure,
wherein the bitstream is further generated to include the chroma reference line index.

9. The method of claim 8, wherein a luma reference line index value associated with the first set of references lines non-adjacent to the luma CU used in the luma intra prediction procedure and the chroma reference line index value associated with the second set of reference lines non-adjacent to the chroma CU are different values.

10-28. (canceled)

29. A method of decoding by a decoder, comprising:
receiving, by a communication interface, a bitstream that includes a set of luma pixel values associated with a luma coding unit (CU) and a set of chroma pixel values associated with a chroma CU from an image encoder; and
identifying, by at least one processor, a correlation function associated with a first set of reference lines non-adjacent to the luma CU and used to generate the set of luma pixel values by the image encoder and a second set of references line non-adjacent to the chroma CU and used to generate the set of chroma pixel values by the image encoder.

30. The method of claim 29, further comprising:
decoding, by the at least one processor, the bitstream based on the correlation function to identify the set of luma pixel values associated with the luma CU and the set of chroma pixel values associated with the chroma CU; and
generating, by the at least one processor, an enhanced image based on the set of luma pixel values associated with the luma CU and the set of chroma pixel values associated with the chroma CU.

31. The method of claim 30, further comprising:
identifying, by the at least one processor, information associated with a luma reference line index associated with the first set of references lines non-adjacent to the luma CU from the bitstream or information associated with a chroma reference line index associated with the second set of reference lines non-adjacent to the chroma CU,
wherein the correlation function is identified based on the luma reference line index.

32. The method of claim 31, wherein a luma reference line index value associated with the first set of references lines non-adjacent to the luma CU and a chroma reference line index value associated with the second set of reference lines non-adjacent to the chroma CU are a same value.

33. The method of claim 29, wherein:
the second set of reference lines non-adjacent to the chroma CU include the first set of reference lines non-adjacent to the luma CU and a reference line located above the first set of reference lines non-adjacent to the luma CU, and
the correlation function is identified based on the second set of reference lines non-adjacent to the chroma CU that include the first set of reference lines non-adjacent to the luma CU and the reference line located above the first set of reference lines non-adjacent to the luma CU.

34. The method of claim 29, wherein:
the second set of reference lines non-adjacent to the chroma CU include the first set of reference lines non-adjacent to the luma CU and a reference line located below the first set of reference lines non-adjacent to the luma CU, and
the correlation function is identified based on the second set of reference lines non-adjacent to the chroma CU that include the first set of reference lines non-adjacent to the luma CU and the reference line located below the first set of reference lines non-adjacent to the luma CU.

35. The method of claim 29, wherein:
the bitstream further includes a chroma reference line index associated with the second set of reference lines non-adjacent to the chroma CU, and
the correlation function is identified based on the chroma reference line index associated with the second set of reference lines non-adjacent to the chroma CU.

36. The method of claim 35, wherein a luma reference line index value associated with the first set of references lines non-adjacent to the luma CU and the chroma reference line index value associated with the second set of reference lines non-adjacent to the chroma CU are different values.

37. The method of claim 36, wherein:
the bitstream further includes an indication of a delta value associated with a difference between the first set of reference lines non-adjacent to the luma CU and the second set of reference lines non-adjacent to the chroma CU, and
the correlation function is identified based on the indication of the delta value.

38. The method of claim 37, wherein a coding tree structure associated with the luma CU and the chroma CU is the same.

39. The method of claim 37, wherein:
the indication includes a bit set to a first value to indicate a negative delta value, or
the indication includes a bit set to a second value different than the first value to indicate a positive delta value.

40. The method of claim 37, wherein the indication includes the delta value.

41. The method of claim 37, wherein the indication does not include the delta value.

42. A system for decoding by a decoder, comprising:
at least one processor; and
memory storing instructions, which when executed by the at least one processor, cause the at least one processor to:
receive a bitstream that includes a set of luma pixel values associated with a luma coding unit (CU) and a set of chroma pixel values associated with a chroma CU from an image encoder; and
identify a correlation function associated with a first set of reference lines non-adjacent to the luma CU and used to generate the set of luma pixel values by the image encoder and a second set of references line non-adjacent to the chroma CU and used to generate the set of chroma pixel values by the image encoder.

43-54. (canceled)
